(19) United States
(12) Patent Application Publication
(10) Pub. No.: US 2014/0349671 A1
(43) Pub. Date: Nov. 27, 2014

(54) INDOOR POSITIONING WITH ASSISTANCE DATA LEARNING

(71) Applicant: QUALCOMM Incorporated, San Diego, CA (US)

(72) Inventors: Abdelmonaem Lakhzouri, Tampere (FI); Florean Curticapean, Tampere (FI)

(73) Assignee: QUALCOMM Incorporated, San Diego, CA (US)

(21) Appl. No.: 13/899,437

(22) Filed: May 21, 2013

(51) Int. Cl. H04W 4/04

(52) U.S. Cl. CPC H04W 4/04
USPC 455/456.1

(57) ABSTRACT

Methods, apparatus, and computer program products for determining a position of a mobile device in a network service area are described. An example of a method for determining the position of the mobile device includes receiving a positioning request for the position of the mobile device and, in response to receiving the positioning request, receiving signal characteristic measurements, estimating an a priori mobile device position area based on the signal characteristic measurements, determining a selected AD model, and determining the position of the mobile device using the selected AD model.

### BACKGROUND

Characteristics of signals transmitted between mobile devices and network access points (APs) or other radio transmitters can be measured and analyzed to provide network-based positioning capabilities for the mobile devices. Network-based, or terrestrial, positioning can be particularly useful in network service areas, often indoor areas, where weak or inconsistent satellite signals render satellite based positioning systems inaccessible or inaccurate. Typical signal characteristics measured by the APs and received by a position determination module can include round trip time (RTT), received signal strength indicator (RSSI), and channel frequency response (CFR). The position determination module can determine a mobile device location using measured signal characteristics and assistance data (AD) models. AD models can be signal propagation models which describe signal attenuation in a particular network service area due to signal absorption and reflection by environmental features of the network service area. Examples of environmental features can be building materials, furniture materials and configurations, a number and position of occupants, and the interior architectural configuration of rooms, hallways, doors, and walls. The environmental features of the network service area can define the parameters of the AD models. Diversity of environmental features and temporal changes in environmental features can increase the deviation between the calculated signal characteristics from the AD models and the measured signal characteristics and, therefore, decrease mobile device positioning accuracy. Using an AD learning process, the deviation of AD modeled and calculated signal characteristics from measured signal characteristics can be evaluated in an iterative manner in order to dynamically update and improve the AD models used for mobile device positioning in a network service area. Such a dynamically updated model may improve position determination accuracy despite complexities and temporal variations in environmental features.

### SUMMARY

An example of a method of determining a position of a mobile device in a network service area according to the disclosure may include receiving a first positioning request for the position of the mobile device and, in response to receiving the first positioning request, receiving first signal characteristic measurements, estimating a first a priori mobile device position area based on the first signal characteristic measurements, determining a selected AD model, and determining the position of the mobile device using the selected AD model.

Implementations of such a method may include one or more of the following features. The method may include storing a first position information based on the position of the mobile device and sending a first position information based on the position of the mobile device. Determining the selected AD model may include calculating signal characteristics for each AD model of a set of AD models, comparing the calculated signal characteristics with the first signal characteristic measurements to determine a first deviation for each AD model, for each AD model, determining a first confidence score based on the first deviation, comparing the first confidence score of each AD model to a confidence score threshold to determine a first qualifying set of AD models, determining a first cost function based on the first qualifying set of AD models and the first signal characteristic measurements, and determining the selected AD model that minimizes the first cost function and is one AD model of the first qualifying set of AD models. The confidence score threshold may be heuristically determined and adjustable. The method may include comparing the calculated signal characteristics with a statistical parameter based on the first signal characteristic measurements and stored signal characteristic measurements to determine the first deviation for each AD model. The statistical parameter may include a mean or a weighted mean. The network service area may be divided into a plurality of sectors, each sector of the plurality of sectors being a section of the network service area. Determining the selected AD model may include calculating signal characteristics for each sector for each AD model of a set of AD models, comparing the first signal characteristic measurements with the calculated signal characteristics for each sector to determine a first deviation for each AD model for each sector, determining a first confidence score for each AD model for each sector based on the first deviation for each AD model for each sector, comparing the first confidence score of each AD model for each sector to a confidence score threshold to determine a first qualifying set of AD models for each sector, determining a first cost function based on the first qualifying set of AD models for each sector and the first signal characteristic measurements, and determining the selected AD model for each sector that minimizes the first cost function evaluated at each sector and is one AD model of the first qualifying set of AD models. A number of sectors may be dynamically adjusted based on the determined confidence score for each AD model. Determining the selected AD model may include calculating signal characteristics for each sector within the estimated first a priori mobile device position area for each AD model of a set of AD models, comparing the first signal characteristic measurements with the calculated signal characteristics for each sector within the estimated first a priori mobile device position area to determine a first deviation for each AD model for each sector within the estimated first a priori mobile device position area, determining a first confidence score for each AD model for each sector within the estimated first a priori mobile device position area based on the first deviation for each AD model for each sector within the estimated first a priori mobile device position area, comparing the first confidence score of each AD model for each sector within the estimated first a priori mobile device position area to a confidence score threshold to determine a first qualifying set of AD models for each sector within the estimated first a priori mobile device position area, determining a first cost function based on the first qualifying set of AD models for each sector within the estimated first a priori mobile device position area and the first signal characteristic measurements, and, for each sector within the estimated first a priori mobile device position area, determining the selected AD model for each sector within the estimated first a priori mobile device position area that minimizes the first cost function evaluated at each sector within the estimated first a priori mobile device position area and is one AD model of the set of qualifying AD models. The method may include receiving a second positioning request and, in response to receiving the second positioning request, receiving second signal characteristic measurements, estimating a second a priori mobile device position area based on the second signal characteristic measurements, determining a selected AD model confidence score based on the second signal characteristic measurements, and determining the selected AD model confidence score to be an acceptable confidence score or an unacceptable confidence score. In response to the selected AD model confidence score being the acceptable confidence score, the method may include calculating signal characteristics for each AD model of a set of AD models, comparing the second signal characteristic measurements with the calculated signal characteristics to determine a second deviation for each AD model, determining a second confidence score for each AD model based on the second deviation, and determining the position of the mobile device using the selected AD model. In response to the selected AD model confidence score being the unacceptable confidence score, the method may include calculating signal characteristics for each AD model of a set of AD models, comparing the second signal characteristic measurements with the calculated signal characteristics to determine a second deviation for each AD model, and determining a second confidence score for each AD model based on the second deviation, comparing the second confidence score of each AD model to a confidence score threshold to determine a second qualifying set of AD models, determining a second cost function based on the second qualifying set of AD models and the second signal characteristic measurements, determining an updated selected AD model that minimizes the second cost function and is one AD model of the qualifying set of AD models, and determining the position of the mobile device using the updated selected AD model.

An example of a method for determining a position of a mobile device in a network service area according to the disclosure may include sending a first positioning request and receiving first position information based on the position of the mobile device determined, in response to the first positioning request, by receiving first signal characteristic measurements, estimating a first a priori mobile device position area based on the first signal characteristic measurements, determining a selected AD model, and determining the position of the mobile device using the selected AD model.

Implementation of such a method may include one or more of the following features. Determining the selected AD model may include calculating signal characteristics for each AD model of a set of AD models, comparing the calculated signal characteristics with the first signal characteristic measurements to determine a first deviation for each AD model, for each AD model, determining a first confidence score based on the first deviation, comparing the first confidence score of each AD model to a confidence score threshold to determine a first qualifying set of AD models, determining a first cost function based on the first qualifying set of AD models and the first signal characteristic measurements, and determining the selected AD model that minimizes the first cost function and is one AD model of the first qualifying set of AD models. The network service area may be divided into a plurality of sectors, each sector of the plurality of sectors being a section of the network service area. Determining the selected AD model may include calculating signal characteristics for each sector for each AD model of a set of AD models, comparing the first signal characteristic measurements with the calculated signal characteristics for each sector to determine a first deviation for each AD model for each sector, determining a first confidence score for each AD model for each sector based on the first deviation for each AD model for each sector, comparing the first confidence score of each AD model for each sector to a confidence score threshold to determine a first qualifying set of AD models for each sector, determining a first cost function based on the first qualifying set of AD models for each sector and the first signal characteristic measurements, and determining the selected AD model for each sector that minimizes the first cost function evaluated at each sector and is one AD model of the first qualifying set of AD models. The method may include sending a second positioning request and receiving second position information based on the position of the mobile device determined, in response to the second positioning request, by receiving second signal characteristic measurements, estimating a second a priori mobile device position area based on the second signal characteristic measurements, determining a selected AD model confidence score based on the second signal characteristic measurements, determining the selected AD model confidence score to be an acceptable confidence score or an unacceptable confidence score. In response to the selected AD model confidence score being the acceptable confidence score, the method may include calculating signal characteristics for each AD model of a set of AD models, comparing the second signal characteristic measurements with the calculated signal characteristics to determine a second deviation for each AD model, determining a second confidence score for each AD model based on the second deviation, and determining the position of the mobile device using the selected AD model. In response to the confidence score of the selected AD model being the unacceptable confidence score, the method may include calculating signal characteristics for each AD model of the set of AD models, comparing the second signal characteristic measurements with the calculated signal characteristics to determine the second deviation for each AD model, determining the second confidence score for each AD model based on the second deviation, comparing the second confidence score of each AD model to a confidence score threshold to determine a second qualifying set of AD models, determining a second cost function based on the second qualifying set of AD models and the second signal characteristic measurements, determining an updated selected AD model that minimizes the second cost function and is one AD model of the set of AD models, and determining the position of the mobile device using the updated selected AD model.

An example of an apparatus for determining a position of a mobile device in a network service area according to the disclosure may include one or more processors configured to receive a first positioning request for the position of the mobile device. In response to receiving the first positioning request, the one or more processors may be configured to receive first signal characteristic measurements, estimate a first a priori mobile device position area based on the first signal characteristic measurements, determine a selected AD model, and determine the position of the mobile device using the selected AD model.

Implementations of such an apparatus may include one or more of the following features. The apparatus may include a memory configured to store a first position information based on the position of the mobile device. The one or more processors may be configured to send a first position information based on the position of the mobile device. The one or more processors may be configured to determine the selected AD model by calculating signal characteristics for each AD model of a set of AD models, comparing the calculated signal characteristics with the first signal characteristic measurements to determine a first deviation for each AD model, determining a first confidence score for each AD model based on the first deviation, comparing the first confidence score of each AD model to a confidence score threshold to determine a first qualifying set of AD models, determining a first cost function based on the first qualifying set of AD models and the first signal characteristic measurements, and determining the selected AD model that minimizes the first cost function and is one AD model of the first qualifying set of AD models. The confidence score threshold may be heuristically determined and adjustable. The one or more processors may be configured to compare the calculated signal characteristics with a statistical parameter based on the first signal characteristic measurements and stored signal characteristic measurements to determine the first deviation for each AD model. The statistical parameter may include a mean or a weighted mean. The network service area may be divided into a plurality of sectors, each sector of the plurality of sectors being a section of the network service area. The one or more processors may be configured to determine the selected AD model by steps including calculating signal characteristics for each sector for each AD model of a set of AD models, comparing the first signal characteristic measurements with the calculated signal characteristics for each sector to determine a first deviation for each AD model for each sector, determining a first confidence score for each AD model for each sector based on the first deviation for each AD model for each sector, comparing the first confidence score of each AD model for each sector to a confidence score threshold to determine a first qualifying set of AD models for each sector, determining a first cost function based on the first qualifying set of AD models for each sector and the first signal characteristic measurements, and determining the selected AD model for each sector that minimizes the first cost function evaluated at each sector and is one AD model of the first qualifying set of AD models. A number of sectors may be dynamically adjusted based on the determined confidence score for each AD model. The one or more processors may be configured to determine the selected AD model by steps including calculating signal characteristics for each sector within the estimated first a priori mobile device position area for each AD model of a set of AD models, comparing the first signal characteristic measurements with the calculated signal characteristics for each sector within the estimated first a priori mobile device position area to determine a first deviation for each AD model for each sector within the estimated first a priori mobile device position area, determining a first confidence score for each AD model for each sector within the estimated first a priori mobile device position area based on the first deviation for each AD model for each sector within the estimated first a priori mobile device position area, comparing the first confidence score of each AD model for each sector within the estimated first a priori mobile device position area to a confidence score threshold to determine a first qualifying set of AD models for each sector within the estimated first a priori mobile device position area, determining a first cost function based on the first qualifying set of AD models for each sector within the estimated first a priori mobile device position area and the first signal characteristic measurements, and determining the selected AD model for each sector within the estimated first a priori mobile device position area that minimizes the first cost function evaluated at each sector within the estimated first a priori mobile device position area and is one AD model of the set of qualifying AD models. The one or more processors may be configured to receive a second positioning request, and, in response to receiving the second positioning request, receive second signal characteristic measurements, estimate a second a priori mobile device position area based on the second signal characteristic measurements, determine a selected AD model confidence score based on the second signal characteristic measurements, and determine the selected AD model confidence score to be an acceptable confidence score or an unacceptable confidence score. In response to the selected AD model confidence score being the acceptable confidence score, the one or more processors may be configured to calculate signal characteristics for each AD model of the set of AD models, compare the second signal characteristic measurements with the calculated signal characteristics to determine a second deviation for each AD model, determine a second confidence score for each AD model based on the second deviation, and determine the position of the second mobile device using the selected AD model. In response to the selected AD model confidence score being the unacceptable confidence score, the one or more processors may be configured to calculate signal characteristics for each AD model of a set of AD models, compare the second signal characteristic measurements with the calculated signal characteristics to determine the second deviation for each AD model, determine a second confidence score for each AD model based on the second deviation, compare the second confidence score of each AD model to a confidence score threshold to determine a second qualifying set of AD models, determine a second cost function based on the second qualifying set of AD models and the second signal characteristic measurements, and determine an updated selected AD model that minimizes the second cost function and is one AD model of the qualifying set of AD models, and determine the position of the second mobile device using the updated selected AD model.

An example of an apparatus for determining a position of a mobile device in a network service area according to the disclosure may include a transceiver configured to send a first positioning request and receive first position information based on the first position of the mobile device determined, in response to the first positioning request, by receiving first signal characteristic measurements, estimating a first a priori mobile device position area based on the first signal characteristic measurements, determining a selected AD model, and determining the first position of the mobile device using the selected AD model.

Implementation of such an apparatus may include one or more of the following features. Determining the selected AD model may include calculating signal characteristics for each AD model of a set of AD models, comparing the calculated signal characteristics with the first signal characteristic measurements to determine a first deviation for each AD model, determining a first confidence score for each AD model based on the first deviation, comparing the first confidence score of each AD model to a confidence score threshold to determine a first qualifying set of AD models, determining a first cost function based on the first qualifying set of AD models and the first signal characteristic measurements, and determining the selected AD model that minimizes the first cost function and is one AD model of the first qualifying set of AD models. The network service area may be divided into a plurality of sectors, each sector of the plurality of sectors being a section of the network service area. Determining the selected AD model may include calculating signal characteristics for each sector for each AD model of a set of AD models, comparing the first signal characteristic measurements with the calculated signal characteristics for each sector to determine a first deviation for each AD model for each sector, determining a first confidence score for each AD model for each sector based on the first deviation for each AD model for each sector, comparing the first confidence score of each AD model for each sector to a confidence score threshold to determine a first qualifying set of AD models for each sector, determining a first cost function based on the first qualifying set of AD models for each sector and the first signal characteristic measurements, and determining the selected AD model for each sector that minimizes the first cost function evaluated at each sector and is one AD model of the first qualifying set of AD models. The transceiver may be configured to send a second positioning request and, in response to the second positioning request, receive second position information based on the position of the mobile device determined by receiving second signal characteristic measurements, estimating a second a priori mobile device position area based on the second signal characteristic measurements, determining a selected AD model confidence score based on the second signal characteristic measurements, and determining the selected AD model confidence score to be an acceptable confidence score or an unacceptable confidence score. In response to the selected AD model confidence score being the acceptable confidence score, the position of the mobile device may be determined by calculating signal characteristics for each AD model of a set of AD models, comparing the second signal characteristic measurements with the calculated signal characteristics to determine a second deviation for each AD model, determining a second confidence score for each AD model based on the second deviation, and determining the position of the mobile device using the selected AD model. In response to the confidence score of the selected AD model being the unacceptable confidence score, the position of the mobile device may be determined by calculating signal characteristics for each AD model of the set of AD models, comparing the second signal characteristic measurements with the calculated signal characteristics to determine the second deviation for each AD model, determining the second confidence score for each AD model based on the second deviation, comparing the second confidence score of each AD model to a confidence score threshold to determine a second qualifying set of AD models, determining a second cost function based on the second qualifying set of AD models and the second signal characteristic measurements, and determining an updated selected AD model that minimizes the second cost function and is one AD model of the set of AD models, and determining the position of the mobile device using the updated selected AD model.

An example of an apparatus for determining a position of a mobile device in a network service area according to the disclosure may include means for receiving a first positioning request for the position of the mobile device and means for, in response to receiving the first positioning request, receiving first signal characteristic measurements, estimating a first a priori mobile device position area based on the first signal characteristic measurements, determining an AD model, and determining the position of the mobile device using the selected AD model.

Implementations of such an apparatus may include one or more of the following features. The apparatus may include means for storing a first position information based on the position of the mobile device and means for sending a first position information based on the position of the mobile device. The means for determining the selected AD model may include means for calculating signal characteristics for each AD model of a set of AD models, means for comparing the calculated signal characteristics with the first signal characteristic measurements to determine a first deviation for each AD model, means for determining a first confidence score for each AD model based on the first deviation, means for comparing the first confidence score of each AD model to a confidence score threshold to determine a first qualifying set of AD models, means for determining a first cost function based on the first qualifying set of AD models and the first signal characteristic measurements, and means for determining the selected AD model that minimizes the first cost function and is one AD model of the first qualifying set of AD models. The confidence score threshold may be heuristically determined and adjustable. The apparatus may include means for comparing the calculated signal characteristics with a statistical parameter based on the first signal characteristic measurements and stored signal characteristic measurements to determine a first deviation for each AD mode. The statistical parameter may include a mean or a weighted mean. The network service area may be divided into a plurality of sectors, each sector of the plurality of sectors being a section of the network service area. The means for determining the selected AD model may include means for calculating signal characteristics for each sector for each AD model of a set of AD models, means for comparing the first signal characteristic measurements with the calculated signal characteristics for each sector to determine a first deviation for each AD model for each sector, means for determining a first confidence score for each AD model for each sector based on the first deviation for each AD model for each sector, means for comparing the first confidence score of each AD model for each sector to a confidence score threshold to determine a first qualifying set of AD models for each sector, means for determining a first cost function based on the first qualifying set of AD models for each sector and the first signal characteristic measurements, and means for determining the selected AD model for each sector that minimizes the first cost function evaluated at each sector and is one AD model of the first qualifying set of AD models. A number of sectors may be dynamically adjusted based on the determined confidence score for each AD model. The network service area may be divided into a plurality of sectors, each sector of the plurality of sectors being a section of the network service area. The means for determining the selected AD model may include means for calculating signal characteristics for each sector within the estimated first a priori mobile device position area for each AD model of a set of AD models, means for comparing the first signal characteristic measurements with the calculated signal characteristics for each sector within the estimated first a priori mobile device position area to determine a first deviation for each AD model for each sector within the estimated first a priori mobile device position area, means for determining a first confidence score for each AD model for each sector within the estimated first a priori mobile device position area based on the first deviation for each AD model for each sector within the estimated first a priori mobile device position area, means for comparing the first confidence score of each AD model for each sector within the estimated first a priori mobile device position area to a confidence score threshold to determine a first qualifying set of AD models for each sector within the estimated first a priori mobile device position area, means for determining a first cost function based on the first qualifying set of AD models for each sector within the estimated first a priori mobile device position area and the first signal characteristic measurements, and means for determining the selected AD model for each sector within the estimated first a priori mobile device position that minimizes the first cost function evaluated at each sector within the estimated first a priori mobile device position area and is one AD model of the set of qualifying AD models. The apparatus may include means for receiving a second positioning request and means for, in response to receiving the second positioning request, receiving second signal characteristic measurements, estimating a second a priori mobile device position area based on the second signal characteristic measurements, determining a selected AD model confidence score based on the second signal characteristic measurements, and determining the selected AD model confidence score to be an acceptable confidence score or an unacceptable confidence score. The apparatus may include means for, in response to the selected AD model confidence score being the acceptable confidence score, calculating signal characteristics for each AD model of a set of AD models, comparing the second signal characteristic measurements with the calculated signal characteristics to determine a second deviation for each AD model, determining a second confidence score for each AD model based on the second deviation, and determining the position of the mobile device using the selected AD model. The apparatus may include means for, in response to the confidence score of the selected AD model being the unacceptable confidence score, calculating signal characteristics for each AD model of a set of AD models, comparing the second signal characteristic measurements with the calculated signal characteristics to determine a second deviation for each AD model, determining a second confidence score for each AD model based on the second deviation, comparing the second confidence score of each AD model to a confidence score threshold to determine a second qualifying set of AD models, determining a second cost function based on the second qualifying set of AD models and the second signal characteristic measurements, determining an updated selected AD model that minimizes the second cost function and is one AD model of the qualifying set of AD models, and determining the position of the mobile device using the updated selected AD model.

An example of an apparatus for determining a position of a mobile device in a network service area according to the disclosure may include means for sending a first positioning request and means for receiving first position information based on the position of the mobile device determined, in response to the first positioning request, by receiving first signal characteristic measurements, estimating a first a priori mobile device position area based on the first signal characteristic measurements, determining a selected AD model, and determining the position of the mobile device using the selected AD model.

Implementations of such an apparatus may include one or more of the following features. Determining the selected AD model may include calculating signal characteristics for each AD model of a set of AD models, comparing the calculated signal characteristics with the first signal characteristic measurements to determine a first deviation for each AD model, determining a first confidence score for each AD model based on the first deviation, comparing the first confidence score of each AD model to a confidence score threshold to determine a first qualifying set of AD models, determining a first cost function based on the first qualifying set of AD models and the first signal characteristic measurements, and determining the selected AD model that minimizes the first cost function and is one AD model of the first qualifying set of AD models. The network service area may be divided into a plurality of sectors, each sector of the plurality of sectors being a section of the network service area. Determining the selected AD model may include calculating signal characteristics for each sector for each AD model of a set of AD models, comparing the first signal characteristic measurements with the calculated signal characteristics for each sector to determine a first deviation for each AD model for each sector, determining a first confidence score for each AD model for each sector based on the first deviation for each AD model for each sector, comparing the first confidence score of each AD model for each sector to a confidence score threshold to determine a first qualifying set of AD models for each sector, determining a first cost function based on the first qualifying set of AD models for each sector and the first signal characteristic measurements, and determining the selected AD model for each sector that minimizes the first cost function evaluated at each sector and is one AD model of the first qualifying set of AD models. The apparatus may include means for sending a second positioning request and means for receiving second position information based on the position of the mobile device determined, in response to the second positioning request, by receiving second signal characteristic measurements, estimating a second a priori mobile device position area based on the second signal characteristic measurements, determining a selected AD model confidence score based on the second signal characteristic measurements, determining the selected AD model confidence score to be an acceptable confidence score or an unacceptable confidence score. In response to the selected AD model confidence score being the acceptable confidence score, the position of the mobile device may be determined by calculating signal characteristics for each AD model of a set of AD models, comparing the second signal characteristic measurements with the calculated signal characteristics to determine a second deviation for each AD model, determining a second confidence score for each AD model based on the second deviation, and determining the position of the mobile device using the selected AD model. In response to the confidence score of the selected AD model being the unacceptable confidence score, the position of the mobile device may be determined by calculating signal characteristics for each AD model of the set of AD models, comparing the second signal characteristic measurements with the calculated signal characteristics to determine the second deviation for each AD model, determining the second confidence score for each AD model based on the second deviation, comparing the second confidence score of each AD model to a confidence score threshold to determine a second qualifying set of AD models, determining a second cost function based on the second qualifying set of AD models and the second signal characteristic measurements, determining an updated selected AD model that minimizes the second cost function and is one AD model of the set of AD models, and determining the position of the mobile device using the updated selected AD model.

An example of a computer program product residing on a processor-readable non-transitory storage medium according to the disclosure may include processor-readable instructions executable by one or more processors to receive a first positioning request for a position of a mobile device and, in response to receiving the first positioning request, receive first signal characteristic measurements, estimate a first a priori mobile device position area based on the first signal characteristic measurements, determine a selected AD model, and determine the position of the mobile device to be the position of the mobile device determined using the selected AD model.

Implementations of such a computer program product may include one or more of the following features. The computer program product may include processor-readable instructions executable by one or more processors to store a first position information based on the position of the mobile device and send a first position information based on the position of the mobile device. The processor-readable instructions executable by one or more processors to determine the selected AD model may include instructions to calculate signal characteristics for each AD model of a set of AD models, compare the calculated signal characteristics with the first signal characteristic measurements to determine a first deviation for each AD model, determine a first confidence score for each AD model based on the first deviation, compare the first confidence score of each AD model to a confidence score threshold to determine a first qualifying set of AD models, determine a first cost function based on the first qualifying set of AD models and the first signal characteristic measurements, and determine the selected AD model that minimizes the first cost function and is one AD model of the first qualifying set of AD models. The confidence score threshold may be heuristically determined and adjustable. The computer program product may include processor-readable instructions executable by one or more processors to compare the calculated signal characteristics with a statistical parameter based on the first signal characteristic measurements and stored signal characteristic measurements to determine a first deviation for each AD model. The statistical parameter may include a mean or a weighted mean. The network service area may be divided into a plurality of sectors, each sector of the plurality of sectors being a section of the network service area. The processor-readable instructions executable by one or more processors to determine the selected AD model may include instructions to calculate signal characteristics for each sector for each AD model of a set of AD models, compare the first signal characteristic measurements with the calculated signal characteristics for each sector to determine a first deviation for each AD model for each sector, determine a first confidence score for each AD model for each sector based on the first deviation for each AD model for each sector, compare the first confidence score of each AD model for each sector to a confidence score threshold to determine a first qualifying set of AD models for each sector, determine a first cost function based on the first qualifying set of AD models for each sector and the first signal characteristic measurements, and determine the selected AD model for each sector that minimizes the first cost function evaluated at each sector and is one AD model of the first qualifying set of AD models. A number of sectors may be dynamically adjusted based on the determined confidence score for each AD model. The network service area may be divided into a plurality of sectors, each sector of the plurality of sectors being a section of the network service area. The processor-readable instructions executable by one or more processors to determine the selected AD model may include instructions to calculate signal characteristics for each sector within the estimated first a priori mobile device position area for each AD model of a set of AD models, compare the first signal characteristic measurements with the calculated signal characteristics for each sector within the estimated first a priori mobile device position area to determine a first deviation for each AD model for each sector within the estimated first a priori mobile device position area, determine a first confidence score for each AD model for each sector within the estimated first a priori mobile device position area based on the first deviation for each AD model for each sector within the estimated first a priori mobile device position area, compare the first confidence score of each AD model for each sector within the estimated first a priori mobile device position area to a confidence score threshold to determine a first qualifying set of AD models for each sector within the estimated first a priori mobile device position area, determine a first cost function based on the first qualifying set of AD models for each sector within the estimated first a priori mobile device position area and the first signal characteristic measurements, and determine the selected AD model for each sector within the estimated first a priori mobile device position area that minimizes the first cost function evaluated at each sector within the estimated first a priori mobile device position area and is one AD model of the set of qualifying AD models. The computer program product may include processor-readable instructions executable by one or more processors to receive a second positioning request and, in response to receiving the second positioning request, receive second signal characteristic measurements, estimate a second a priori mobile device position area based on the second signal characteristic measurements, determine a selected AD model confidence score based on the second signal characteristic measurements, and determine the selected AD model confidence score to be an acceptable confidence score or an unacceptable confidence score. The computer program product may include processor-readable instructions executable by one or more processors to, in response to the selected AD model confidence score being the acceptable confidence score, calculate signal characteristics for each AD model of a set of AD models, compare the second signal characteristic measurements with the calculated signal characteristics to determine a second deviation for each AD model, determine a second confidence score for each AD model based on the second deviation, and determine the position of the mobile device using the selected AD model. The computer program product may include processor-readable instructions executable by one or more processors to, in response to the confidence score of the selected AD model being the unacceptable confidence score, calculate signal characteristics for each AD model of a set of AD models, compare the second signal characteristic measurements with the calculated signal characteristics to determine a second deviation for each AD model, determine a second confidence score for each AD model based on the second deviation, compare the second confidence score of each AD model to a confidence score threshold to determine a second qualifying set of AD models, determine a second cost function based on the second qualifying set of AD models and the second signal characteristic measurements, determine an updated selected AD model that minimizes the second cost function and is one AD model of the qualifying set of AD models, and determine the position of the mobile device using the updated selected AD model.

An example of a computer program product residing on a processor-readable non-transitory storage medium according to the disclosure may include processor-readable instructions executable by one or more processors to send a first positioning request and receive first position information based on the position of the mobile device determined, in response to the first positioning request, by receiving first signal characteristic measurements, estimating a first a priori mobile device position area based on the first signal characteristic measurements, determining a selected AD model, and determining the position of the mobile device using the selected AD model.

Implementations of such a computer program product may include one or more of the following features. Determining the selected AD model may include calculating signal characteristics for each AD model of a set of AD models, comparing the calculated signal characteristics with the first signal characteristic measurements to determine a first deviation for each AD model, determining a first confidence score for each AD model based on the first deviation, comparing the first confidence score of each AD model to a confidence score threshold to determine a first qualifying set of AD models, determining a first cost function based on the first qualifying set of AD models and the first signal characteristic measurements, and determining the selected AD model that minimizes the first cost function and is one AD model of the first qualifying set of AD models. The network service area may be divided into a plurality of sectors, each sector of the plurality of sectors being a section of the network service area. Determining the selected AD model may include calculating signal characteristics for each sector for each AD model of a set of AD models, comparing the first signal characteristic measurements with the calculated signal characteristics for each sector to determine a first deviation for each AD model for each sector, determining a first confidence score for each AD model for each sector based on the first deviation for each AD model for each sector, comparing the first confidence score of each AD model for each sector to a confidence score threshold to determine a first qualifying set of AD models for each sector, determining a first cost function based on the first qualifying set of AD models for each sector and the first signal characteristic measurements, and determining the selected AD model for each sector that minimizes the first cost function evaluated at each sector and is one AD model of the first qualifying set of AD models. The computer program product may include processor-readable instructions executable by one or more processors to send a second positioning request and, in response to the second positioning request, receive second position information based on the position of the mobile device determined by receiving second signal characteristic measurements, estimating a second a priori mobile device position area based on the second signal characteristic measurements, determining a selected AD model confidence score based on the second signal characteristic measurements, and determining the selected AD model confidence score to be an acceptable confidence score or an unacceptable confidence score. In response to the selected AD model confidence score being the acceptable confidence score, the position of the mobile device may be determined by calculating signal characteristics for each AD model of a set of AD models, comparing the second signal characteristic measurements with the calculated signal characteristics to determine a second deviation for each AD model, determining a second confidence score for each AD model based on the second deviation, and determining the position of the mobile device using the selected AD model. In response to the confidence score of the selected AD model being the unacceptable confidence score, the position of the mobile device may be determined by calculating signal characteristics for each AD model of the set of AD models, comparing the second signal characteristic measurements with the calculated signal characteristics to determine the second deviation for each AD model, determining the second confidence score for each AD model based on the second deviation, comparing the second confidence score of each AD model to a confidence score threshold to determine a second qualifying set of AD models, determining a second cost function based on the second qualifying set of AD models and the second signal characteristic measurements, determining an updated selected AD model that minimizes the second cost function and is one AD model of the set of AD models, and determining the position of the mobile device using the updated selected AD model.

In accordance with implementations of the invention, one or more of the following capabilities may be provided. In response to receiving a positioning request, signal characteristic measurements can be received. An a priori mobile device position area can be estimated based on the signal characteristic measurements. Signal characteristics can be calculated for a set of AD models. A confidence score for each AD model can be determined based on a determined deviation between the calculated signal characteristics and the signal characteristic measurements. The confidence scores can be compared to a threshold to determine a qualifying set of AD models for a cost function. The cost function can be determined based on the qualifying set of AD models and the signal characteristic measurements. A selected AD model can be determined that minimizes the cost function. The position of the mobile device can be determined using the selected AD model. The selected AD model can be updated for a subsequent positioning request based on a selected AD model confidence score determined based on subsequent signal characteristic measurements. Other capabilities may be provided and not every implementation according to the disclosure must provide any, let alone all, of the capabilities discussed. Further it may be possible for an effect noted above to be achieved by means other than that noted and a noted item/technique may not necessarily yield the noted effect.

### BRIEF DESCRIPTIONS OF THE DRAWINGS

In the appended figures, similar components and/or features may have the same reference label. Further, various components of the same type may be distinguished by following the reference label with a dash and a second label that distinguished among the similar components. If only the first reference label is used in the specification, the description is applicable to any one of the similar components having the same first reference label irrespective of the second reference label.

FIG. 1 is a diagram of system components for a network based mobile device positioning system with assistance data learning.

FIG. 1A is a schematic diagram of mobile device system components.

FIG. 1B is a schematic diagram of system of positioning request and position information exchange.

FIG. 1C is a schematic diagram of a system of signal transmission, signal characteristic measurement request, and signal characteristic measurement transmission.

FIG. 2 is a process diagram for a method of network based mobile device positioning with assistance data learning.

FIG. 3 is a process diagram for assistance data learning.

FIG. 4 is an example of a scoring table.

FIG. 5 is a schematic diagram of sector selection based on an a priori mobile device position.

FIG. 6 is a process diagram for multiple sector assistance data learning.

### DETAILED DESCRIPTION

Techniques are provided for positioning of a mobile device using software and/or hardware implemented algorithms which iteratively evaluate and improve the AD models used for mobile device positioning. The techniques discussed below are by way of example only and not limiting as other implementations in accordance with the disclosure are possible. Described techniques may be implemented as a method, apparatus, or system and can be embodied in computer-readable media.

A positioning request for a particular mobile device is received. In response to the positioning request, measurements of signal characteristics are requested from APs in the network service area. An a priori mobile device position area is estimated from the received signal characteristic measurements and a previously stored set of AD models. The network service area is divided into multiple sectors. For each sector within the estimated a priori mobile device position area, a deviation between calculated signal characteristics using the AD models and measured signal characteristics is determined. A confidence score for each model in each sector is calculated based on the deviation and is stored in a scoring table. The confidence scores are compared with a confidence score threshold to determine a qualifying set of AD models with confidence scores greater than or equal to the confidence score threshold. A cost function for the network area is determined using the signal characteristic measurements and the qualifying set of AD models. The mobile device position is determined using a selected AD model for each sector that mathematically minimizes the cost function evaluated in each sector. A subsequent positioning request is received for the same mobile device as the prior positioning request or for a different mobile device than the prior positioning request. With the subsequent positioning request, the confidence score of the selected AD model for each sector is determined based on measured signal characteristics received with the subsequent positioning request and determined to be unacceptable or acceptable. If the confidence score of the selected AD model for each sector is determined to be unacceptable, then the selected AD model for each sector is updated by repeating the steps of determining deviations, determining confidence scores, determining a qualifying set of AD models, determining a cost function, and minimizing the cost function. The mobile device position is determined using the updated selected AD model for each sector. If the confidence score of the selected AD model for each sector is determined to be acceptable, then the confidence scores of the AD models are updated and stored in a scoring table and the mobile device position is determined using the selected AD models from a prior positioning request. By evaluating the confidence scores of the selected AD models with each positioning request and updating the selected AD models if the confidence score is unacceptable, the AD models used to determine the mobile device positions are dynamically updated and improved.

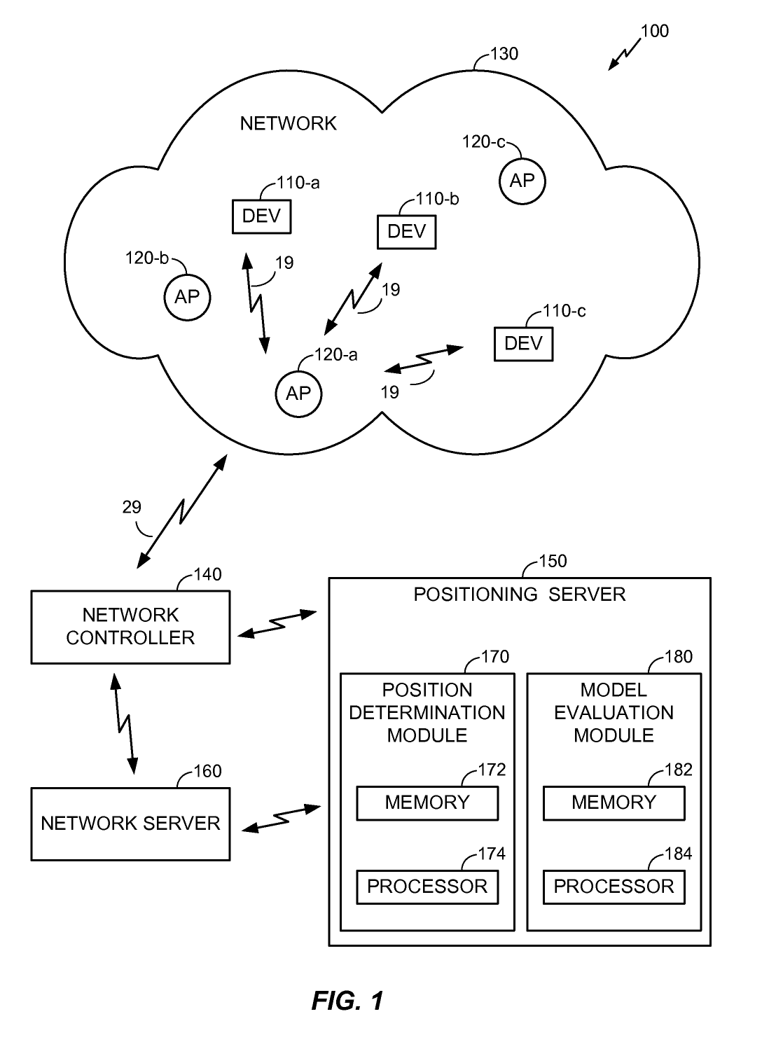

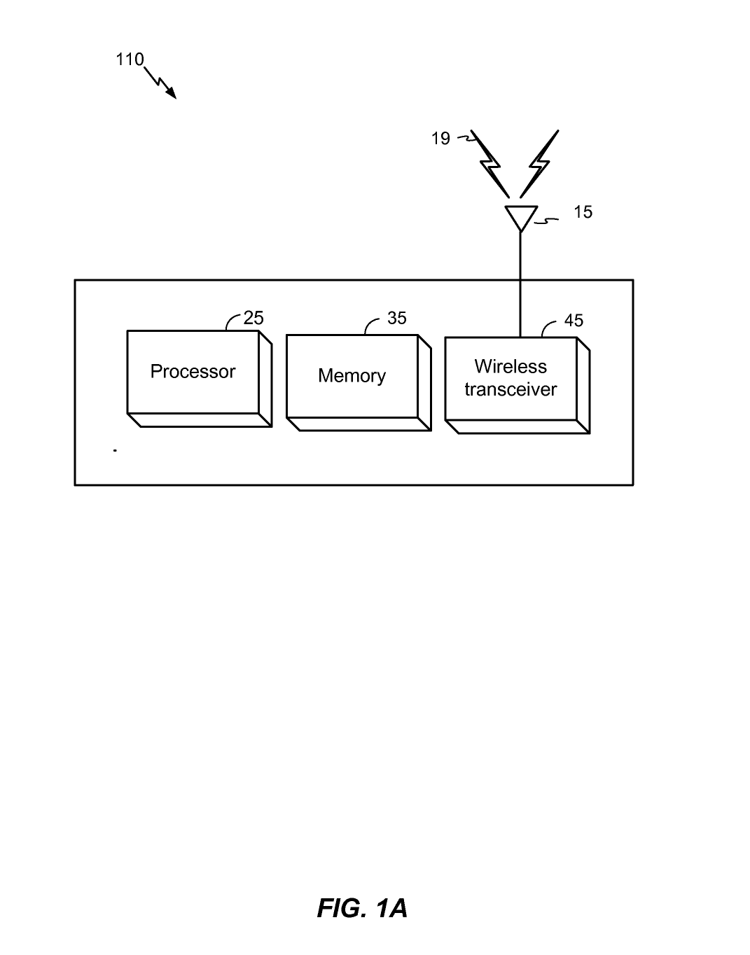

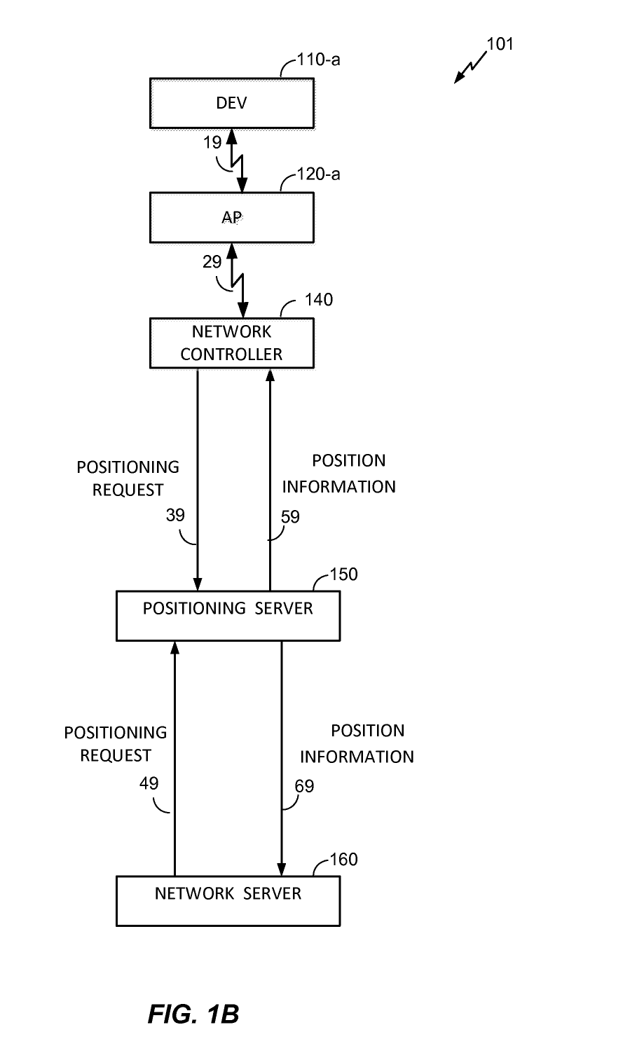

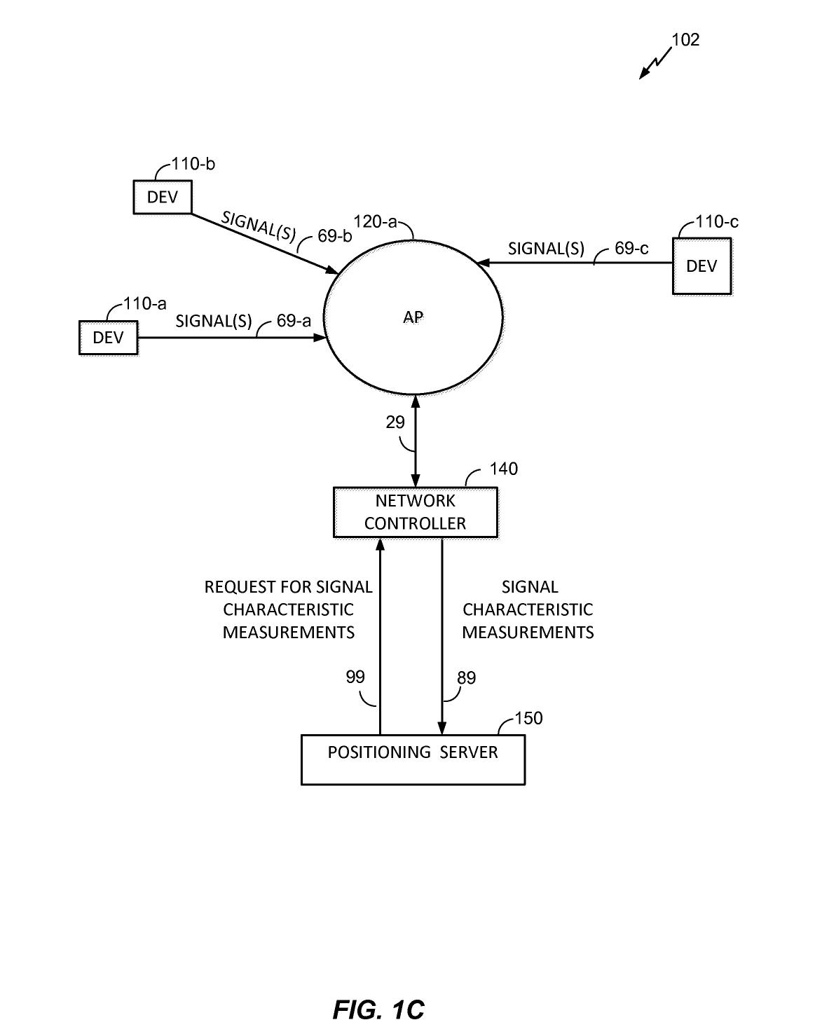

Referring to FIG. 1, a system 100 is shown for determining a position of a mobile device with assistance data learning. The system 100 is by way of example only and not limiting and may be altered, e.g., by having components added, removed, rearranged, or combined. In an embodiment, the system 100 can include one or more mobile devices 110-a, 110-b, and 110-c (sometimes collectively referred to as mobile devices 110), one or more APs 120-a, 120-b, and 120-c (sometimes collectively referred to as APs 120), network 130, one or more wireless local area network (WLAN) controllers 140, one or more positioning servers 150, and one or more network servers 160.

Mobile devices 110, APs 120, network controller(s) 140, network server(s) 160, and positioning server(s) 150 may, for example, be enabled (e.g., via one or more network interfaces) for use with various communication network(s) 130 via wireless and/or wired communication links. Examples of such communication network(s) 130 include but are not limited to a wireless wide area network (WWAN), a wireless local area network (WLAN), and a wireless personal area network (WPAN), and so on. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and so on. A CDMA network may implement one or more radio access technologies (RATs) such as cdma2000, Wideband-CDMA (W-CDMA), Time Division Synchronous Code Division Multiple Access (TD-SCDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may include an IEEE 802.11x network, and a WPAN may include a Bluetooth network, an IEEE 802.15x, for example. Wireless communication networks may include so-called next generation technologies (e.g., “4G”), such as, for example, Long Term Evolution (LTE), Advanced LTE, WiMax, Ultra Mobile Broadband (UMB), and/or the like.

The network 130 may be associated with a network service area. The network service area may constitute all or part of an indoor structure. Examples of indoor structures, not limiting of the invention, include schools, office buildings, stores, stadiums, arenas, convention centers, malls, a collection of buildings connected by tunnels, bridges, walkways, etc., airports, amusement parks, gardens, courtyards, parking lots, academic or business campuses, and any combinations or sub-sections thereof. For example, but not limiting of the invention, a network service area may be one or more entire indoor structures or a particular floor, room, area, group of floors, or group of rooms in an indoor structure.

The network controller 140 can manage and control network communications between the one or more APs 120 and the positioning and network servers, 150 and 160. The network controller 140 includes hardware and software for managing and controlling these communications.

The one or more APs 120 can communicate with the network controller 140 and with one or more mobile devices 110. The one or more APs 120, which may be wireless APs (WAPs), may be any type of terrestrial radio transmitter used in conjunction with the one or more mobile devices 110 and network 130 including, for example, WiFi/WLAN APs, femtocell nodes or transceivers, pico cell nodes or transceivers, WiMAX node devices, beacons, WiFi base stations, a Node B, an evolved Node B (EnB), Bluetooth transceivers, etc. Each AP 120-a, b, and c may be a moveable node, or may be otherwise capable of being relocated. Three APs 120 are shown in FIG. 1 however this number is an example and not limiting; any number of APs 120 may be associated with and/or included in network 130. The number of APs 120 may be K where K is an integer greater than or equal to one.

In an embodiment, each AP 120-a, b, and c is associated with a unique AP identifier, for example a MAC address, and is configured to collect various types of signal characteristic measurements including, for example, but not limited to RTT, RSSI, and CFR. The AP identifier can be used by the position determination module 170 to identify a network service area known to include the identified AP.

Mobile devices 110 are intended to be representative of any electronic device that may be reasonably moved about by a user. Examples of mobile devices 110 may include, but are not limited to, a wireless chip, a mobile station, a mobile phone, a smartphone, a user equipment, a netbook, a laptop computer, a tablet or slate computer, an entertainment appliance, a navigation device and any combination thereof. Claimed subject matter is not limited to any particular type, category, size, capability etc. of mobile device. The mobile device may be operatively associated with one or more cellular networks or the like.

Three mobile devices 110 are shown in FIG. 1 however this number is an example and not limiting; any number of mobile devices 110 may be associated with and/or included in network 130.

Referring to FIG. 1A with reference to FIG. 1, components included in an example of a mobile device 110 are illustrated. The one or more mobile devices 110 include a wireless transceiver 45 that sends and receives wireless signals 19 via a wireless antenna 15 over wireless network 130. The wireless signals 19 are shown in FIG. 1 between each wireless device 110-a, b, and c and AP 120-a for clarity and not limiting of the invention; wireless signals 19 are transmitted from any mobile device 110 to and from any AP 120. The transceiver 45 is communicatively coupled to a mobile device processor 25 and a mobile device memory 35. Here, the mobile device 110 is illustrated as having a single wireless transceiver 45. However, a mobile device 110 can alternatively have multiple wireless transceivers 45 and wireless antennas 15 to support multiple communication standards such as Wi-Fi, Code Division Multiple Access (CDMA), Wideband CDMA (WCDMA), Long Term Evolution (LTE), Bluetooth, etc.

While only one processor and one memory are shown in FIG. 1A, more than one of any of these components could be part of the one or more mobile devices 110. It will be understood as used herein that the processor 25 can, but need not necessarily include, one or more microprocessors, embedded processors, controllers, application specific integrated circuits (ASICs), digital signal processors (DSPs) and the like. The term processor is intended to describe the functions implemented by the system rather than specific hardware. Storage of information from the wireless signals 19 is performed using the memory 35. The memory 35 includes a non-transitory computer-readable storage medium (or media) that stores functions as one or more instructions or code. The term memory, as used herein, refers generally to any type of computer storage medium, including but not limited to RAM, ROM, FLASH, disc drives, etc. . . . Memory 35 may be long term, short term, or other memory associated with the one or more mobile devices 110 and is not to be limited to any particular type of memory or number of memories, or type of media upon which memory is stored.

Functions stored by the memory 35 may be executed by the processor 25. Thus, the memory 35 is a processor-readable memory and/or a computer-readable memory that stores software code (programming code, instructions, etc.) configured to cause the processor 25 to perform the functions described. Alternatively, one or more functions of the one or more mobile devices 110 may be performed in whole or in part in hardware.

Referring again to FIG. 1, the network controller 140 is communicatively coupled to the positioning server 150 and the network server 160. The positioning server 150 and the network server 160 may communicate with the one or more APs 120 using the network controller 140. The positioning server 150 and the network server 160 are shown separately in FIG. 1 for clarity. However, the positioning server 150 may be implemented in or may be the same as the network server 160. The positioning server 150 and/or network server 160 may be physically located in or near the network service area or may be remotely located and both servers may service one or more network service areas.

In an embodiment, the positioning server 150 may include a position determination module 170 and a model evaluation module 180. The position determination module 170 may include a memory 172 and a processor 174. Similarly, the model evaluation module 180 may include a memory 182 and a processor 184. The processors 174 and 184 may be one or more microprocessors, embedded processors, controllers, application specific integrated circuits (ASICs), digital signal processors (DSPs) and the like. The term processor is intended to describe the functions implemented by the system rather than specific hardware. Memory 172 and 182 may be any non-transitory computer-readable storage medium (or media) that stores functions as one or more instructions or code including but not limited to RAM, ROM, FLASH, disc drives, etc., may be long term or short term, and may not to be limited to any particular type of memory or number of memories, or type of media upon which memory is stored.

In an embodiment, the position determination module 170 and the model evaluation module 180 may reside in the positioning server 150 and/or the network server 160. Any processor 174 and 184 and/or memory 172 and 182 used or associated with the position determination module 170 and/or the model evaluation module 180 may be used or associated with other functions of the positioning server 150 and/or the network server 160 and may not be hardware specifically or uniquely allocated for use by the position determination module and the model evaluation module.

Functions stored by memory 172 and 182 may be executed by either processor 174 and 184. Thus, memory 172 and 182 are each processor-readable memory and/or computer-readable memory that stores software code (programming code, instructions, etc.) configured to cause the processor 174 and/or 184 to perform the functions described.

Only one processor, one memory, and one of each module type are shown in FIG. 1, however this number is an example and not limiting of the invention. The position determination module 170 and the model evaluation module 180 are illustrated separately for clarity but may be part of a single module with shared processor functions implemented based on instructions in software stored in a shared memory.

Referring to FIG. 1B with reference to FIG. 1, a system 101 for positioning request and position information exchange is shown. The position determination module processor 174 of the positioning server 150 can receive a positioning request 39 and/or a positioning request 49 to determine a location or position of a particular mobile device to be located, 110-a, b, or c. As used herein, the terms location and position are synonymous and interchangeable. In an embodiment, the positioning request 39 can be initiated by the processor 25 of a particular mobile device, 110-a, b, or c, and sent to the position determination module processor 174 of the positioning server 150 via the transmitted signals 19 from the transceiver 45 and the antenna 15 to AP 120-a, b, or c and via transmitted signals 29 to the network controller 140. Mobile device 110-a is shown in FIG. 1B as an example only and not limiting of the invention; any of the one or more mobile devices 110 may be similarly represented in FIG. 1B. Similarly, AP 120-a is shown in FIG. 1B as an example only and not limiting of the invention; any of the one or more APs 120 may be similarly represented in FIG. 1B. In an embodiment, the positioning request 49 can be initiated by the network server 160 and sent to the positioning server 150.

Referring to FIG. 1C with reference to FIG. 1 and FIG. 1B, a system 102 of signal transmission, signal characteristic measurement request, and signal characteristic measurement transmission is shown. The position determination module processor 174 of the positioning server 150 may send a request 99 for signal characteristic measurements 89 to AP 120-a, b, or c via the transmitted signals 29 between the network controller 140 and AP 120-a, b, or c. AP 120-a is shown in FIG. 1C as an example only and not limiting of the invention; any of the one or more APs 120 may be similarly represented in FIG. 1C. The AP 120-a, b, or c can measure and collect signal characteristics including, for example, RSSI, RTT, and CFR, for one or more signals 69-a, b, and c transmitted by one or more mobile devices 110-a, b, and c and received by AP 120-a, b, or c. The AP 120-a, b, or c can send the signal characteristic measurements 89 to the position determination module processor 174 of the positioning server 150 via the transmitted signals 29 with the network controller 140. The signal characteristic measurements 89 may be for one or more mobile devices 110 in the network service area and may not be limited to the particular mobile device initiating the positioning request 39 or corresponding to the positioning request 49.

Referring again to FIG. 1, the position determination module processor 174 of the positioning server 150 can receive the signal characteristic measurements collected by APs 120 and can store the collected signal characteristic measurements in memory 172.

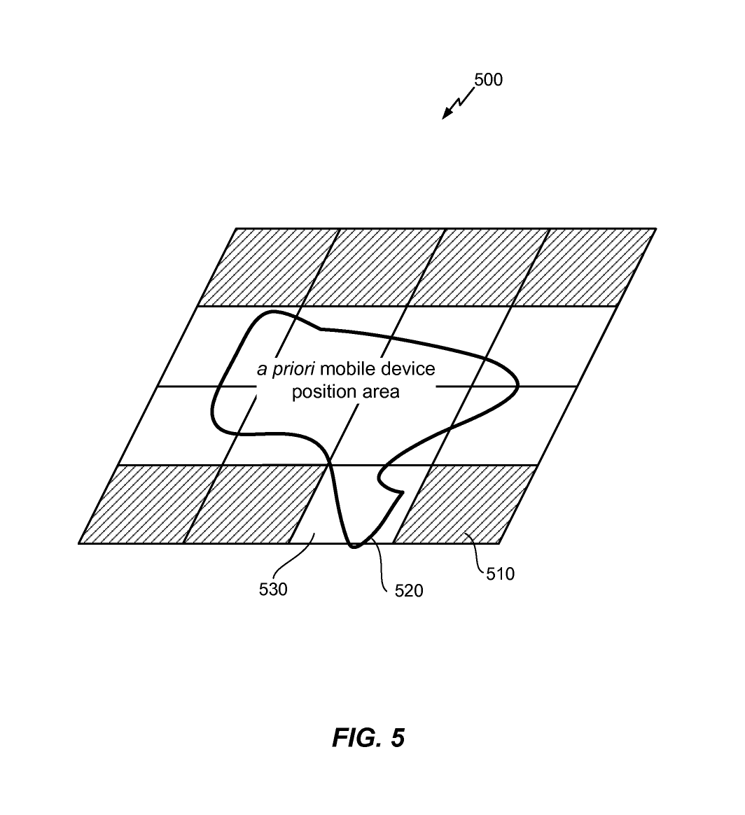

Referring to FIG. 5 with reference to FIG. 1, the position determination module processor 174 can estimate, for the mobile device being located (i.e. mobile device 110-a, b, or c) an a priori mobile device position area bound, for example, by the curvy line 520. The position determination module processor 174 can estimate the a priori mobile device position area by analyzing the signal characteristic measurements stored in the position determination module memory 172 using a database of AD models, previously stored in the model evaluation module memory 182. Given signal characteristic measurements 89, received by the position determination module 174 of the positioning server 150 from any of the one or more APs 120, the database of AD models may be used by the position determination module processor 174 to calculate a set of mobile device positions that could produce such a measured value. The area defined by the calculated set of mobile device positions determines an a priori mobile device position area for the particular mobile device being located.

In an implementation, an a priori mobile device position may be estimated by the position estimation module processor 174 using a prior mobile device position, stored in memory 172, from a previous positioning request for the particular mobile device. In such an implementation, the a priori mobile device position may be determined using the elapsed time between positioning requests and a known or assumed speed and direction of motion associated with the particular mobile device.

The model evaluation module 180 can access a previously stored database of AD models using the processor 184. The database of AD models may reside in memory 182. In an embodiment, the database of AD models may reside on the network server 160. The database of AD models may be associated with the network service area identified by the position determination module 170 using the received AP identifiers. The AD model database can include a set of N models, {AD₁, AD₂, . . . , AD_{N}}, for each AP where N is an integer greater than or equal to one. For a network service area including K APs 120, there may be a total of {N×K} AD models stored in the network service area database in memory 182. In an implementation, the database of AD models may be previously stored offline (i.e. stored prior to mobile device positioning procedures) for a particular network service area. The stored AD models can be available for use by the model evaluation module 180 during mobile device positioning. The AD models can mathematically predict the signal characteristics measured at a particular AP for signals transmitted from any mobile device located in the network service area.

The number of models, N, for each AP can depend on the environmental features of the particular indoor network service area. For example, a structurally complex indoor environment including many types of interspersed building materials (ex. wood, glass, brick, concrete, plastic) may require more AD models than a simpler indoor environment with fewer types of building materials. Additionally, environmental features subject to variation may necessitate multiple models to describe the effects of the possible variations in the environmental features on signal propagation. For example, the number, placement, and motion of occupants in an indoor space may vary (e.g. the number of workers on a day shift versus a night shift, for example). As another example, the positions of doors and/or windows may vary between open and closed.

In an embodiment, the model evaluation module processor 184 can divide, or tile, the network service area into M sectors {S₁, S₂, . . . , S_{M}}. In an embodiment, the model evaluation module processor 184 may determine the sectors offline (i.e. prior to or separately from mobile device positioning procedures) for a particular network service area. The determined sectors may be stored in the model evaluation module memory 182.

In an implementation, the number of sectors, M, may be determined by diversity within the service area with regard to the environmental features. Each sector can be a section of the network service area within which the signal attenuation due to environmental features can be mathematically modeled with an AD signal propagation model using the same modeling parameters everywhere within the sector. For example, each sector may correspond to a section of the network service area with a single, particular type of wall material (i.e. a section with concrete walls) or a particular office configuration in terms of walls, windows, and doors. In general, an AD model may more accurately predict the signal attenuation of a smaller sector due to the reduction in the number, diversity, and fluctuation of environmental features associated with a smaller sector. Smaller sectors can increase the number of sectors, M. In an implementation, an entire network service area may be a single sector. In an implementation, each sector may correspond to a defined interior architectural unit such as a corridor or a room. The number of sectors, M, can depend on the number of types of defined interior architectural units.

In an embodiment, the number of sectors, M, may be determined based on a grid, a map, or other geographic representation of the network service area stored, for example, at the model evaluation module 180. In an embodiment, the number of sectors M may be determined by dividing the network service area into sectors of a fixed size (e.g. area or volume) based on graphic coordinates of a map. In an example, the area of each sector may be a fixed dimension (e.g. 5×5 meters or 10×10 meters).

In an implementation, the number of sectors M may depend on a combination of factors including, but not limited to, environmental feature diversity, number of types of defined interior architectural units, and a grid, map, or geographic representation of the network service area.

Referring again to FIG. 1, the position determination module processor 174 can estimate positions of the one or more mobile devices 110 transmitting the signals from the signal characteristic measurements using, for example, a trilateration algorithm. The positions may be in the form of x, y coordinates on a grid, a map, or other geographic representation of the network service area. In an embodiment, the processor 174 may sort the signal characteristic measurements by position and store the signal characteristic measurements in memory 172 according to sectors so that each sector S_{M} can be associated with a set of measurements. In an embodiment, the processor 174 may calculate and store in memory 172 statistical parameters, for example, mean, weighted mean, or standard deviation, for the stored measurements for each sector S_{M}.

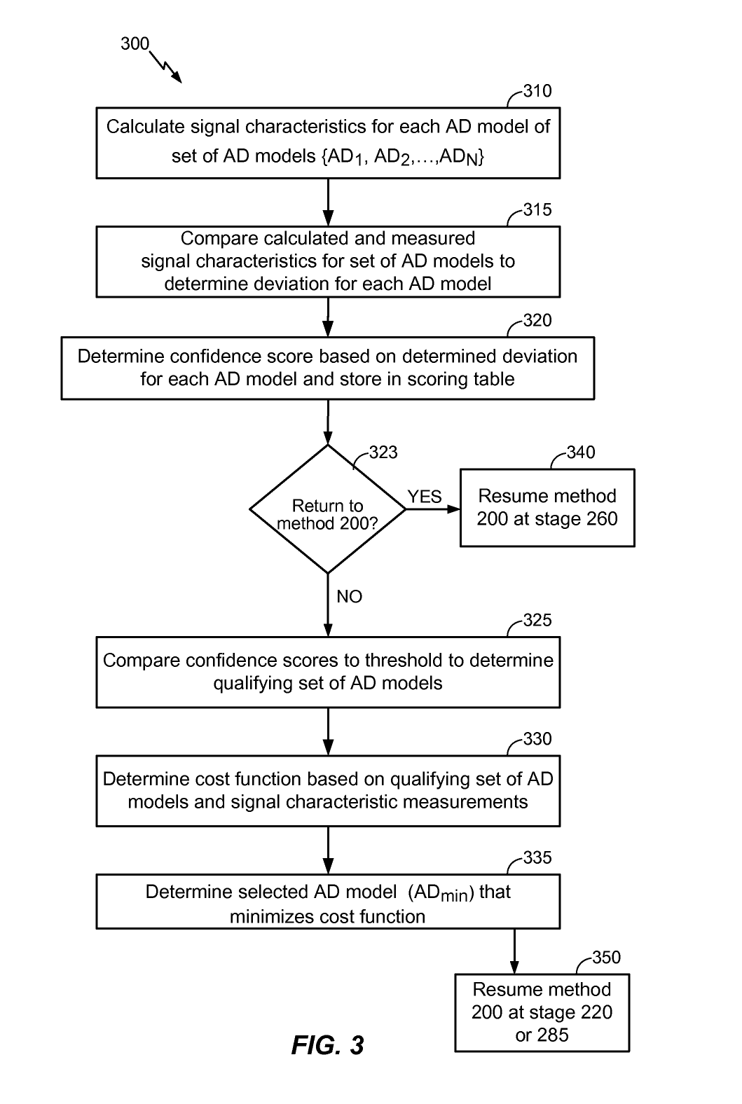

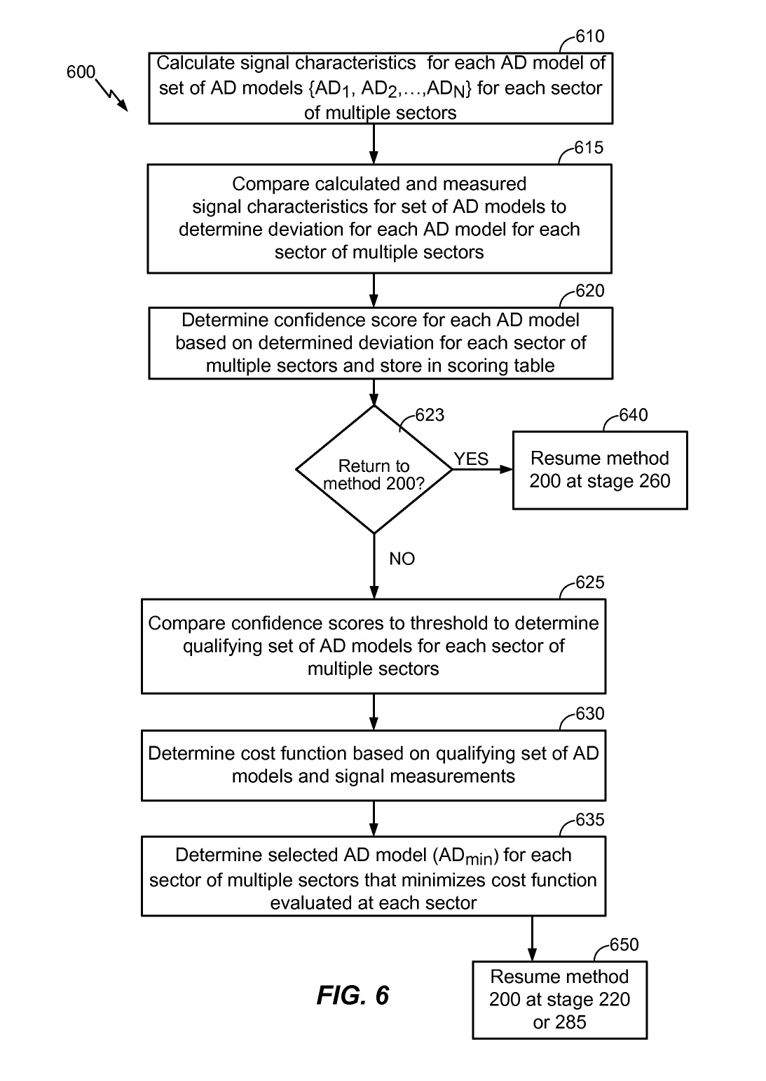

The model evaluation module processor 184 can implement a model evaluation process for AD learning as described in detail below with regard to FIG. 3 and FIG. 6. The model evaluation process may be stored in memory 182 and implemented by the processor 184 to determine and update a selected AD model, referred to herein as ADₘᵢₙ, used for mobile device position determination. In an embodiment, the network service area may correspond to one sector and the model evaluation process may determine one ADₘᵢₙ. In an embodiment, the network service area may be divided into multiple sectors, as described above, and the model evaluation process may determine an ADₘᵢₙ for each sector.

ADₘᵢₙ can be stored in memory 182 and/or memory 172 for use by processor 174 to determine a location of the particular mobile device (e.g. 110-a, b, or c) being located. The processor 174 can store position information based on the determined mobile device position in the memory 172.

Referring to FIG. 1B with reference to FIG. 1, the position determination module processor 174 of the positioning server 150 can transmit position information based on the determined mobile device position. The position determination module processor 174 of the positioning server 150 can send 59 the position information to any mobile device (e.g. 110-a, b, or c) via transmitted signals 29 between the network controller 140 and the AP 120-a, b, or c and transmitted signals 19 between the AP 120-a, b, or c and mobile device 110-a, b, or c. The antenna 15 and wireless transceiver 45 of the particular mobile device being located (e.g. 110-a, b, or c) and/or another mobile device (e.g. 110-a, b, or c) can receive the position information sent 59 by the position determination module processor 174 of positioning server 150. The position information can be stored in memory 35 for use by the processor 25. In an example, the position determination module processor 174 of positioning server 150 can send the position information 69 to the network server 160. The network server 160 can store the position information sent 69 by the position determination module processor 174 of positioning server 150. The network server 160 can be configured to store position information for one or more mobile devices 110 in order to locate and track mobile device assets within the network service area.

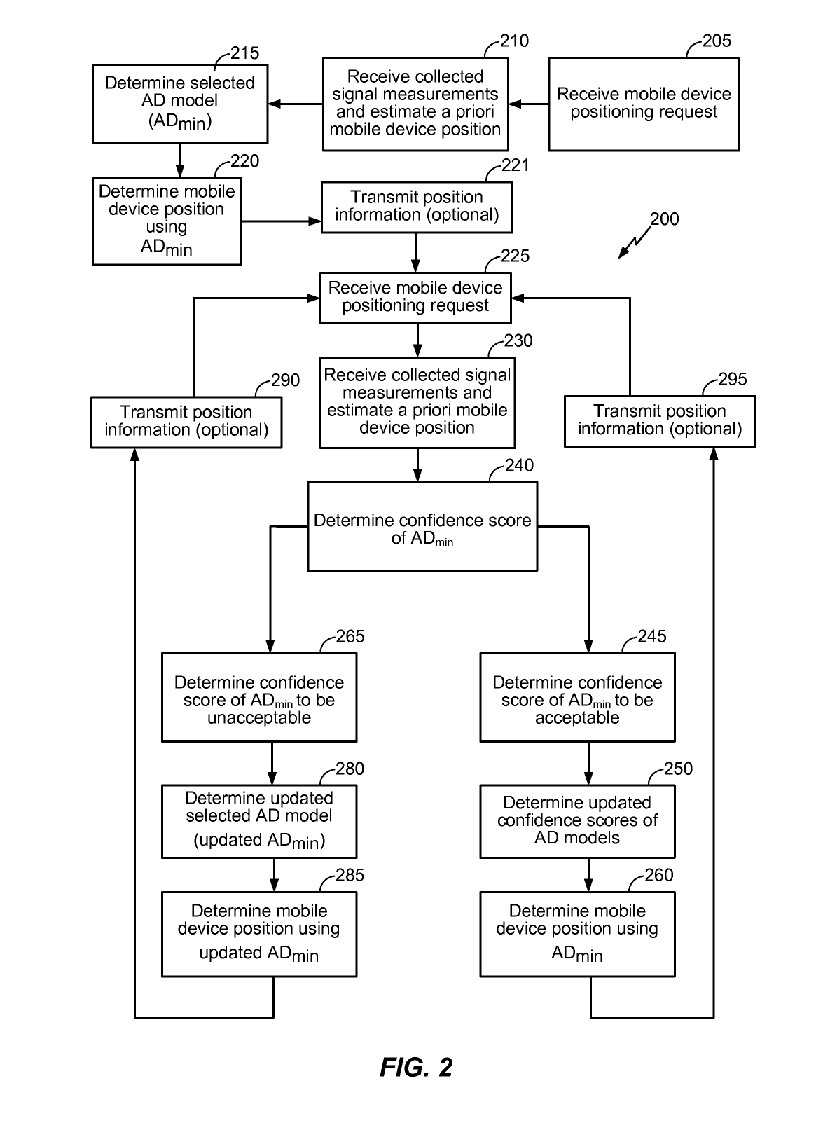

In operation, referring to FIG. 2, with further reference to FIGS. 1 and 3, a method 200 of network based mobile device positioning with assistance data learning includes the stages shown. The method 200, however, is by way of example only and not limiting. The method 200 may be altered, e.g., by having stages added, removed, rearranged, combined, and/or performed concurrently.

A general overview of method 200, not limiting of the invention, may be as follows. Stages 205, 210, 215, 220, and 221 can determine a first selected AD model for use in mobile device positioning and determine the location of the mobile device (i.e., a first mobile device position) using the selected AD model for a first mobile device positioning request. A second positioning request at stage 225 can be an initial step for at least two possible method loops. A first loop, including stages 225, 230, 240, 245, 250, 260, and 295, can determine a second mobile device position using the first selected AD model. A second loop, including stages 225, 230, 240, 265, 280, 285, and 290 can determine the second mobile device position using an updated selected AD model. In general, the first loop can be faster and less computationally intensive than the second loop. Therefore, the first selected AD model may be used repeatedly for multiple positioning requests as long as the confidence score of the first selected AD model can be determined to be acceptable. Conversely, the second loop can be slower and more computationally intensive than the first loop. Therefore, it may be desirable to utilize the second loop only when the confidence score of the first selected AD model may indicate that the accuracy of the first selected AD model may have decreased, for example, due to changes in the environmental features of the network service area after the determination of the first selected AD model. Each iteration of the second loop may update the selected AD model to account for changes in environmental features of the network service area and to maintain mobile device positioning accuracy despite these changes. The updated selected AD model may provide improved positioning accuracy as compared with the first selected AD model. The improved positioning accuracy may result from a reduced deviation between calculated signal characteristics and measured signal characteristics. In general, a reduced deviation for an AD model may indicate that the AD model more accurately predicts measured signal characteristics. Because the updating can occur in conjunction with ongoing positioning requests, the selected AD model from any positioning request may be dynamically updated in conjunction with any subsequent positioning request.

At stage 205, the position determination module 170 can receive a mobile device positioning request to determine the position of a particular mobile device, 110-a, b, or c, in the network service area of network 130. The positioning request may be a first positioning request. In an example, a mobile device 110 initiates the positioning request via the network 130. In an implementation, the network server 160 may initiate the positioning request.

At stage 210, in response to the positioning request, the position determination module 170 can instruct APs 120 to collect signal characteristic measurements from the particular mobile device 110 that is the subject of the positioning request. In an embodiment, the position determination module 170 can instruct APs 120 to collect signal characteristic measurements from one or more mobile devices 110. The signal characteristic measurements may be the first signal characteristic measurements. The position determination module processor 174 can receive the collected signal characteristic measurements. The signal characteristic measurements can include, for example, RSSI, RTT, and CFR.

Additionally, at stage 210, the position determination module processor 174 can estimate an a priori position for the particular mobile device using the collected measurements and stored AD models. The a priori mobile device position can determine an area within which the mobile device is likely to be located. Referring to FIG. 5, such an area is bound, for example, by the curvy line 520.

At stage 215, the model evaluation module processor 184 can determine confidence scores of AD models and determine a selected AD model (ADₘᵢₙ) using a method 300 of assistance data learning or a method 600 of multiple sector assistance data learning, as described below with reference to FIG. 3 and FIG. 6 respectively. The model evaluation module 182 memory and/or the position determination module memory 172 can store the confidence scores and the selected ADₘᵢₙ.

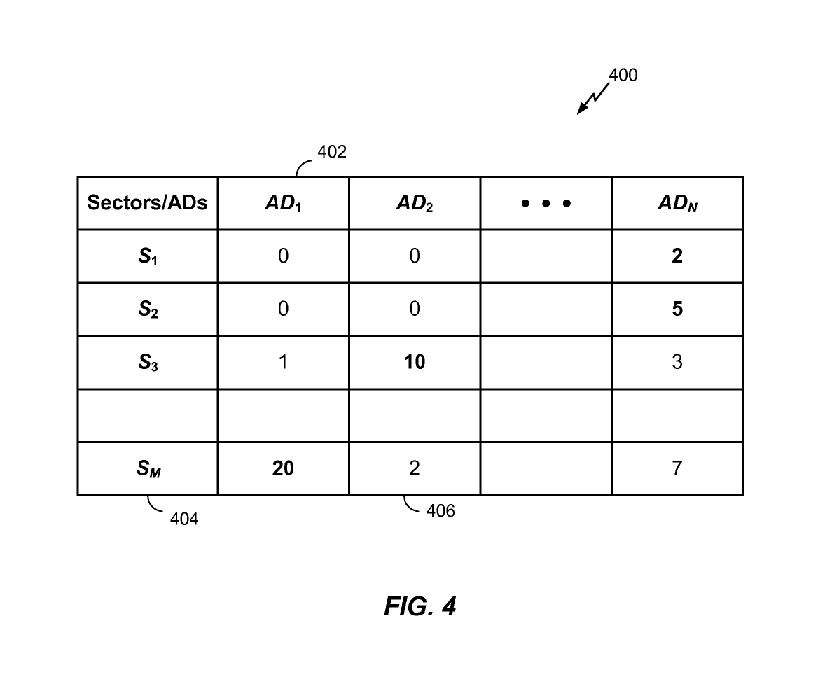

Referring to FIG. 4, the confidence scores can be stored in a data structure stored in memory 182, for example scoring table 400. Scoring table 400 includes AD model columns 402, sector rows 404, and confidence score entry fields 406. Each AD model column 402 corresponds to one of the N models {AD₁, AD₂, . . . , AD_{N}}. Each sector row 404 corresponds to one of the sectors S_{M}. Each particular confidence score entry field 406 contains the confidence score for the AD model of the particular column 402 and the sector of the particular row 404 intersecting the particular confidence score entry field 406. In an embodiment, the network service area may correspond to one sector. In this case, M may equal one and scoring table 400 may have one row. In an embodiment, the network service area may be divided into multiple sectors. In this case, M may be greater than one and the scoring table 400 may have multiple rows, the total number of rows equaling M.

The confidence score determined for the AD models can replace any previously determined confidence score for the AD models. In this manner, the model evaluation module processor 184 can adjust the confidence scores of the AD models. In an implementation, prior to any positioning requests for a network service area, for example prior to stage 205 of FIG. 2, the processor 184 may set all of the initial confidence scores in scoring table 400 to zero. The scoring table 400 can uniquely correspond to an AP for the network service area of network 130.

At stage 220, position determination module processor 174 may determine a position for particular mobile device being located (e.g. 110-a, b, or c) using the selected and stored ADₘᵢₙ model from the assistance data learning process 300. The position determination module processor 170 can communicate the determined position to the particular mobile device being located (e.g. 110-a, b, or c) and/or to the network server 160.

The processor 184 can adjust the confidence score, in scoring table 400 stored in memory 182, for ADₘᵢₙ in the sector S_{M} that includes the calculated mobile device position coordinates. The adjusted confidence score for ADₘᵢₙ may reflect a high likelihood that calculated results from ADₘᵢₙ have the smallest deviation, as compared with the other models, from the measured signal characteristics.

At stage 221, with reference to FIG. 1B, the position determination module processor 174 of the positioning server 150 can optionally transmit position information based on the determined mobile device position. In an embodiment, at stage 221, the position determination module processor 174 of the positioning server 150 can send 59 the position information to any mobile device (e.g. 110-a, b, or c) via transmitted signals 29 between the network controller 140 and the AP 120-a, b, or c and transmitted signals 19 between the AP 120-a, b, or c and mobile device 110-a, b, or c. The particular mobile device being located (e.g. 110-a, b, or c) and/or another mobile device (e.g. 110-a, b, or c) can receive the position information sent 59 by the positioning server 150. In an alternative or additional embodiment, at stage 221, the position determination module processor 174 of the positioning server 150 can send 69 the position information to the network server 160. The network server 160 can store the position information sent 69 by the positioning server 150.

At stage 225, the position determination module 170 can receive a subsequent mobile device positioning request. The subsequent mobile device positioning request may be a second mobile device positioning request. The term second as used herein means subsequent to the first and does not imply a total quantity or a particular ordinal rank. In an embodiment, a mobile device, 110-a, b, or c may initiate the subsequent positioning request. In an embodiment, the network server 160 may initiate the subsequent positioning request. The subsequent positioning request may be for the same particular mobile device as the prior positioning request or for a different particular mobile device than the prior positioning request.

At stage 230, with reference to FIG. 1C, in response to the subsequent positioning request, the position determination module 170 can request 99 signal characteristic measurements from an AP 120-a, b, or c for signals from the particular mobile device 110 that is the subject of the subsequent positioning request. In an embodiment, the position determination module 170 can request 99 signal characteristic measurements from an AP 120-a, b, or c for signals from one or more mobile devices 110. The position determination module processor 174 can receive 89 the collected signal characteristic measurements collected by the AP 120-a, b, or c and store these measurements in memory 172. The received signal characteristic measurements can be second signal characteristic measurements distinct from the first signal characteristic measurements.

Additionally, at stage 230, the position determination module processor 174 can estimate an a priori position for the particular mobile device using the collected measurements and AD models stored in memory 182.

At stage 240, the processor 184 may determine a confidence score for the selected ADₘᵢₙ model based on a deviation between calculated signal characteristics using the selected ADₘᵢₙ and the collected measured signal characteristics. In response to every subsequent received positioning request at stage 225, the position determination module processor 174 can request and receive collected signal characteristic measurements. The processor 174 can combine the received measurements with stored signal characteristic measurements from prior positioning requests. The statistical reliability of the received signal characteristic measurements and associated statistical parameters (e.g. mean, weighted mean, standard deviation) can increase with an increasing number of positioning requests. As a result, the deviation and confidence score determined at stage 240 for ADₘᵢₙ may be more accurate with an increasing number of positioning requests.

The confidence score of ADₘᵢₙ, or any other AD model, can change over a period of time ΔT. ΔT may be a period of any duration, for example, seconds, minutes, hours, days, weeks, months, or years. A detected change in the selected ADₘᵢₙ confidence score may indicate that the selected ADₘᵢₙ is no longer a more accurate model to use for mobile device positioning than the other AD models {AD₁, AD₂, . . . , AD_{N}}. The model evaluation processor 184 may evaluate the selected ADₘᵢₙ confidence score to determine if a change has occurred in response to non-transient changes in the measured signal characteristics or transient changes in the measured signal characteristics compared to the measured signal characteristics received at a prior positioning request.

Non-transient changes in the measured signal characteristics can be due to significant changes in modeled environmental features of the network service area of network 130. For example, a renovation may change the types of building materials, the corridor layout, and/or any other aspects of the interior architecture. Other examples, not limiting of the invention, of significant changes that may occur include rearrangement of furniture, differences in the number and position of occupants, for example between a night work shift and a day work shift, or an alteration of a cubicle partition layout. The position determination module processor 174 may utilize a particular selected ADₘᵢₙ determined for the network service area at time T₁ to determine requested mobile device positions for a period of time ΔT. By time T₂=T₁+ΔT, a significant environmental feature change may occur or have occurred. As a result, the particular selected model ADₘᵢₙ determined at T₁ may be associated with an unacceptable deviation and confidence score at T₂. Dynamically updating ADₘᵢₙ by updating ADₘᵢₙ during a positioning request in response to non-transient changes in the measured signal characteristics may adaptively improve the accuracy of the AD model used for mobile device positioning.

Alternatively, transient changes in the measured signal characteristics may involve, for example, signal propagation parameters that may not be included in the modeled parameters. Examples of sources of transient changes, not limiting of the invention, can include changes in the way a mobile device is held by a user (e.g. various mobile device configurations in, for example, a user's hand, pocket, briefcase, or handbag) and electronic fluctuations in a mobile device battery, transceiver, or other component. Updating the selected ADₘᵢₙ in response to these transient changes may cause the model evaluation module 180 to flicker or bounce between models without any associated improvement in mobile device positioning accuracy. Such model updates can be an unnecessary utilization of computing resources. In an embodiment, the model evaluation module processor 184 may implement routines stored in memory 182 which can statistically evaluate the magnitude (i.e. the size of the shift compared to the confidence score threshold) and frequency (the number of changes per unit time) of detected confidence score changes or shifts. In an implementation, processor 184 can evaluate environmental feature changes identified by an operator of the model evaluation module 180. The statistical routines may be used by the model evaluation module processor 184 to heuristically determine and adjust the confidence score threshold. The

confidence score threshold may be set so that non-transient changes in the measured signal characteristics can result in an unacceptable confidence score evaluation at stage 265 and an updated selected ADₘᵢₙ. In general, the number of mobile device positioning determinations that may occur with any particular selected ADₘᵢₙ depends upon the type, magnitude, and frequency of changes in the modeled environmental features that may occur in the network service area for network 130.

At stage 245, the model evaluation module processor 184 may determine the confidence score for ADₘᵢₙ to be acceptable based on the confidence score threshold. In an implementation, the confidence score threshold can be set so that transient changes in the measured signal characteristics can result in an acceptable confidence score. If the confidence score for ADₘᵢₙ equals or exceeds the confidence score threshold and/or equals or exceeds the confidence score of any other AD model in the scoring table, then the confidence score of ADₘᵢₙ may be determined to be acceptable. As a result, the position determination module processor 174 may continue to use the ADₘᵢₙ, with an acceptable confidence score for one or more subsequent mobile device positioning requests.

Alternatively, at stage 265, the model evaluation module processor 184 may determine the confidence score to be unacceptable. For example, if the confidence score for ADₘᵢₙ is less than the confidence score threshold and/or less than the confidence score of another AD model in the scoring table, then the confidence score of ADₘᵢₙ may be determined to be unacceptable. As a result, the processor 184 may proceed to determine an updated ADₘᵢₙ, store the updated ADₘᵢₙ, in memory 182 and/or 172, and the position determination module 170 may use the stored, updated ADₘᵢₙ for one or more mobile device positioning requests.

In an embodiment, the processor 184 may adjust the confidence score threshold so that the confidence score for ADₘᵢₙ may be determined to be unacceptable at stage 265 because of a long time gap between positioning requests from a particular network service area. The likelihood that positions determined from a particular ADₘᵢₙ may have a high deviation from measurements (i.e. a low confidence score) may increase with longer gaps between positioning requests due to the increased chance that changes in a particular network service area may have occurred during a long time gap between positioning requests. In an embodiment, the time gap considered to be a long time gap can be determined based on a significant change in the frequency of positioning requests (i.e. the number of positioning requests occurring per unit time). A user or operator of the model evaluation module 180 may decide that a time gap is a long time gap, for example, based on user knowledge of positioning request frequencies or of environmental feature changes. An unacceptable confidence score, for example, zero, may be assigned to a particular model ADₘᵢₙ in order to implement the model evaluation process following a long time gap between positioning requests.

Referring again to FIG. 2, at stage 250, following an acceptable confidence score determination at stage 245, the model evaluation module 180 can determine updated confidence scores of the set of AD models {AD₁, AD₂, . . . , AD_{N}} using stages 310, 315, and 320 of the method 300 of assistance data learning or stages 610, 615, and 620 of multiple sector assistance data learning, as described below with reference to FIG. 3 and FIG. 6 respectively. Since ADₘᵢₙ can correspond to the particular AD model of the set of AD models that mathematically minimizes the cost function, the determined and adjusted AD model confidence scores can include the confidence score of ADₘᵢₙ.

At stage 260, the position determination module processor 174 can determine a position for the particular mobile device being located using the selected ADₘᵢₙ model as determined in conjunction with a prior positioning request. In an embodiment, the position determination module memory 172 can store position information based on the determined mobile device position. In an embodiment, the model evaluation processor 182 can update the confidence score for selected AD model for the sector corresponding to the determined mobile device position to indicate a higher confidence score.

At stage 295, with reference to FIG. 1B, the position determination module processor 174 of the positioning server 150 can optionally transmit position information based on the determined mobile device position. In an embodiment, at stage 295, the position determination module processor 174 of the positioning server 150 can send 59 the position information to any mobile device (e.g. 110-a, b, or c) via transmitted signals 29 between the network controller 140 and the AP 120-a, b, or c and transmitted signals 19 between the AP 120-a, b, or c and mobile device 110-a, b, or c. The particular mobile device being located (e.g. 110-a, b, or c) and/or another mobile device (e.g. 110-a, b, or c) can receive the position information sent 59 by the positioning server 150. In an alternative or additional embodiment, at stage 295, the position determination module processor 174 of the positioning server 150 can send 69 the position information to the network server 160. The network server 160 can store the position information sent 69 by the position determination module processor 174 of the positioning server 150.

Following stage 260 or optional stage 295, process 200 can return to 225 in response to a subsequent mobile device positioning request.

At stage 280, following an unacceptable confidence score determination at stage 265, the model evaluation module processor 184 can determine confidence scores of AD models and determine an updated selected ADₘᵢₙ using a method 300 of assistance data learning or a method 600 of multiple sector assistance data learning, as described below with reference to FIG. 3 and FIG. 6 respectively. The model evaluation module 182 memory and/or the position determination module memory 172 can store the updated selected ADₘᵢₙ.

The updated selected ADₘᵢₙ can replace the selected ADₘᵢₙ determined with the initial positioning request. Subsequently, the position determination module processor 174 can continue to use the updated selected ADₘᵢₙ to determine mobile device positions in response to positioning requests as long as the confidence score of the updated selected ADₘᵢₙ is determined to be acceptable at stage 245. With every subsequent positioning request for which stage 280 is implemented to determine the updated selected ADₘᵢₙ, the updated selected ADₘᵢₙ can replace the selected ADₘᵢₙ or the updated selected ADₘᵢₙ from a prior positioning request.

At stage 285, the position determination module processor 174 may determine a position for the particular mobile device being located using the updated selected ADₘᵢₙ model as determined at stage 280. The updated selected ADₘᵢₙ be an improvement over a prior selected ADₘᵢₙ determined in a prior iteration. This improvement may refer to a reduced deviation, between signal characteristics calculated with ADₘᵢₙ and the measured signal characteristics. An ADₘᵢₙ with a reduced deviation, may improve the mobile device positioning accuracy. The model evaluation processor 182 can be configured to update the confidence score for selected AD model for the sector corresponding to the determined mobile device position to indicate a higher confidence score.

At stage 290, with reference to FIG. 1B, the position determination module processor 174 of the positioning server 150 can optionally transmit position information based on the determined mobile device position. At stage 290, the position determination module processor 174 of the positioning server 150 may send 59 the position information to any mobile device (e.g. 110-a, b, or c) via transmitted signals 29 between the network controller 140 and the AP 120-a, b, or c and transmitted signals 19 between the AP 120-a, b, or c and mobile device 110-a, b, or c. The particular mobile device being located (e.g. 110-a, b, or c) and/or another mobile device (e.g. 110-a, b, or c) can receive the position information sent 59 by the positioning server 150. In an alternative or additional embodiment, at stage 290, the position determination module processor 174 of the positioning server 150 can send 69 the position information to the network server 160. The network server 160 can store the position information sent 69 by the position determination module processor 174 of the positioning server 150.

Following stage 285 or optional stage 290, process 200 can return to 225 with a subsequent mobile device positioning request.

Referring to FIG. 3, with reference to FIG. 1 and FIG. 2, the method 300 of assistance data learning using the system 100 includes the stages shown in FIG. 3. The method 300 is by way of example only and not limiting. The method 300 may be altered, e.g., by having stages added, removed, rearranged, combined, and/or performed concurrently. The method 300 may be implemented at stages 215, 250, and 280 of method 200. At stage 215, method 300 can be implemented to determine a selected AD model. In this case, method 300 may not return to method 200 at stage 323, may proceed with stages 325, 330, and 335, and at stage 350 may resume method 200 (e.g. at stage 220). At stage 250, method 300 can be implemented to determine updated confidence scores of AD models. In this case, method 300 may return to method 200 at stage 323 and at stage 340 may resume method 200 (e.g. at stage 260). At stage 280, method 300 can be implemented to determine an updated selected AD model. In this case, method 300 may not return to method 200 at stage 323, may proceed with stages 325, 330, and 335, and at stage 350 may resume method 200 (e.g. at stage 285).

At stage 310, using the set of AD models {AD₁, AD₂, . . . , AD_{N}} for each of the APs 120, the processor 184 can be configured to calculate signal characteristics predictive of measured signal characteristics for signals transmitted from one or more mobile devices 110 to APs 120.

At stage 315, for each of APs 120, the processor 184 can be configured to compare the measured signal characteristics stored in the position determination module memory 172 with the calculated signal characteristics from the set of N models {AD₁, AD₂, . . . , AD_{N}} to determine a deviation for each AD model. The deviation corresponds to a difference between the measured signal characteristics measurements and the calculated signal characteristics for each AD model of the set of N models. In an embodiment, the processor 184 can be configured to compare the calculated signal characteristics from each of the N models {AD₁, AD₂, . . . , AD_{N}} with a statistical parameter (e.g. mean or weighted mean) associated with the measured signal characteristics for a current positioning request combined with stored signal characteristics prior positioning requests.

At stage 320, the model evaluation module processor 184 determines a confidence score for each of the models {AD₁, AD₂, . . . , AD_{N}} based on the deviation. The confidence score can represent the likelihood that each model of the set of N models provides the smallest deviation, as compared with the other models, between the calculated signal characteristics and the measured signal characteristics for a given sector. In an implementation, the deviation can be between the calculated signal characteristics and a mean or a weighted mean of signal characteristics measured in response to one or more positioning requests from multiple signals transmitted from one or more mobile devices 110 to a particular AP 120-a, b, or c. A confidence score of zero for a particular model, for example, may indicate a low probability that the particular model provides the smallest deviation. In an implementation, the model evaluation processor 184 can be configured to store the confidence scores in a data structure, for example, scoring table 400 of FIG. 4.

At stage 323, as described above, method 300 may return to method 200 and resume method 200 at stage 340 or may continue to stage 325.

At stage 325, the model evaluation processor 184 can compare the confidence scores to a heuristically determined confidence score threshold in order to qualify AD models for use in a cost function. The confidence score threshold can correspond to a confidence score requirement to qualify an AD model for inclusion in the cost function. In various implementations, the confidence score threshold may be a fixed number or may be a computed value of a qualification function or other algorithm applied to the confidence scores.

In an implementation, if all of the AD models have a confidence score of zero or a confidence score below the confidence score threshold (i.e. none of the AD models meet the confidence score threshold criterion), then all of the AD models may qualify for inclusion in the cost function and the processor 184 may include all of the AD models in the cost function.

At stage 330, the model evaluation module processor 184 can determine a cost function for the network service area of network 130 including signal characteristic measurements and AD models qualified for inclusion in the cost function. Calculated signal characteristics from the included AD models may constitute a prediction vector. The stored measurements may constitute a measurement vector. The cost function may be, for example, a Euclidian distance or a weighted Euclidian distance between the prediction vector and the measurement vector.

In an embodiment, the cost function may correspond to a particular AP 120-a, b, or c. In an additional and/or alternative embodiment, the cost function may combine measurements and AD models for all APs 120.

At stage 335, the module evaluation module processor 184 can determine a selected model, referred to herein as ADₘᵢₙ, from the set of models {AD₁, AD₂, . . . , AD_{N}} that mathematically minimizes the cost function for the network service area. The term minimizes refers to a mathematical operation and is used herein to mean that ADₘᵢₙ mathematically minimizes the cost function as compared to the remaining models in the set of available AD models {AD₁, AD₂, . . . , AD_{N}}. In various implementations, ADₘᵢₙ may correspond to a local minimum or an absolute minimum of the cost function. In an implementation, ADₘᵢₙ can be the AD model associated with the minimum deviation between the calculated signal characteristics from the model and the measured signal characteristics received by the position determination module processor 174. Memory 182 and/or memory 172 can store ADₘᵢₙ for use by the position determination module 170.

In an embodiment, if the cost function corresponds to a particular AP 120-a, b, or c, then the determined model ADₘᵢₙ can correspond to the same particular AP. The ADₘᵢₙ determined for one of AP 120-a, b, or c may or may not be the same ADₘᵢₙ determined for a different one of AP 120-a, b, or c. In an additional and/or alternative embodiment, if the cost function corresponds to combined measurements and AD models for all APs 120, then the model ADₘᵢₙ can correspond to all APs 120.

At stage 350, the method 300 may return to stage 220 or stage 285 of method 200. The ADₘᵢₙ determined at stage 335 may be used at stage 220 or stage 285 of method 200 to determine the mobile device position.

In an embodiment, the model evaluation module processor 184 can divide, or tile, the network service area into multiple sectors {S₁, S₂, . . . , S_{M}}. The assistance data learning process may determine confidence scores and select AD models for each sector. In such an embodiment, referring to FIG. 6, with reference to FIG. 1, FIG. 2, and FIG. 3, the method 600 of multiple sector assistance data learning may be implemented. The method 600 using the system 100 includes the stages shown in FIG. 6. The method 600 is by way of example only and not limiting. The method 600 may be altered, e.g., by having stages added, removed, rearranged, combined, and/or performed concurrently.

Method 600 may be implemented at stages 215, 250, and 280 of method 200. At stage 215, method 600 may be implemented to determine a selected AD model for each sector of multiple sectors. In this case, method 600 may not return to method 200 at stage 623 and may proceed with stages 625, 630, and 635 may resume method 200 (e.g. at stage 220) at stage 650. At stage 250, method 600 can be implemented to determine updated confidence scores for each AD model for each sector. In this case, method 600 may return to method 200 at stage 623 and at stage 640 may resume method 200 (e.g. at stage 260). At stage 280, an updated selected AD model for each sector can be determined via the method 600. In this case, method 600 may not return to method 200 at stage 623, may proceed with stages 625, 630, and 635, and at stage 650 may resume method 200 (e.g. at stage 285).

At stage 610, using the set of AD models {AD₁, AD₂, . . . , AD_{N}} for each of the APs 120, the processor 184 can calculate signal characteristics predictive of measured signal characteristics for each sector of the multiple sectors for signals transmitted from the one or more mobile devices 110 to APs 120.

At stage 615, for each of APs 120, the processor 184 can compare the measured signal characteristics stored in the position determination module memory 172 with the calculated signal characteristics for the set of N models {AD₁, AD₂, . . . , AD_{N}} for each sector to determine a deviation for each AD model for each sector. In an embodiment, the process 184 can compare the calculated signal characteristics for each sector with a statistical parameter (e.g. mean or weighted mean) for each sector based on the measured signal characteristics associated with each sector and the current positioning request combined with stored measured signal characteristics associated with each sector.

At stage 620, the model evaluation module processor 184 can determine a confidence score for each of the models {AD₁, AD₂, . . . , AD_{N}} for each sector based on the deviation for each sector. In an implementation, the confidence scores may be stored in a data structure, for example, scoring table 400 in FIG. 4.

In an embodiment, the model evaluation module processor 184 can be configured to dynamically adjust the number of sectors in response to determined confidence scores. For example, large sectors may be divided into smaller sectors to increase the number of sectors if the confidence scores of the AD models are determined to be too low. The smaller sectors may present less diversity with regard to the environmental features than the larger sectors. AD models evaluated for smaller, less diverse sectors may correspond to a smaller deviation between the measured signal characteristics and the modeled, or calculated, signal characteristics. This adjustment may improve AD model position determination accuracy. In another example, small sectors may be combined into larger sectors to reduce the number of sectors if the small sectors are sufficiently similar to one another with regard to environmental features and/or environmental feature diversity. This adjustment may reduce computing time without increasing the deviation (i.e. reducing the confidence score) between the measured signal characteristics and the calculated signal characteristics from the AD models.

At stage 623, as described above, method 600 may return to method 200 and resume method 200 at stage 640 or may continue to stage 625.

At stage 625, the model evaluation processor 184 can compare the confidence scores for each AD model for each sector to a heuristically determined confidence score threshold in order to qualify AD models for each sector for use in a cost function. A higher confidence score, indicative of a smaller deviation between the modeled signal characteristics and the measured signal characteristics, can indicate a higher predictive accuracy of an AD model for a sector.

The qualifying set of AD models can be those AD models for each sector for which the confidence score equals or exceeds the confidence score threshold. In an implementation, if all of the AD models for a particular sector have a confidence score of zero or a confidence score below the confidence score threshold (i.e. none of the AD models meet the confidence score threshold criterion), then all of the AD models for the particular sector may qualify for inclusion in the cost function. In this case, the processor 184 may include all of the AD models for the particular sector in the cost function.

In an implementation, a larger number M of smaller sectors may increase the resolution of the AD model qualification for inclusion in the cost function. In general, an AD model may more accurately predict the signal attenuation of a smaller sector due to the reduction in the number, diversity, and fluctuation of environmental features associated with a smaller sector. Smaller sectors may increase the resolution by increasing the likelihood that, for a given sector, the confidence score(s) of one or more AD models are significantly higher than the confidence scores of the remaining AD models.

Referring to FIG. 5, in an embodiment, the processor 184 can compare the confidence score threshold to confidence scores for AD models for the subset of sectors associated with the estimated a priori mobile device position area (e.g. as determined at stages 210 and/or 230 in FIG. 2). The estimated a priori mobile device position area can determine an area within which the mobile device is likely to be located. As an example, such an area can be bound by the curvy line 520. The estimated a priori mobile device position area may include the subset of white sectors 530 and may exclude the hatched sectors 510. In an embodiment, the processor 184 may compare confidence scores for each AD model for the subset of white sectors 530 to the confidence score threshold.

At stage 630, the model evaluation module processor 184 can determine a single cost function for the network service area of network 130 including signal characteristic measurements and AD models for each sector qualified for inclusion in the cost function. Calculated signal characteristics from the included AD models for each sector may constitute a prediction vector. The stored measurements may constitute a measurement vector. The cost function may be, for example, a Euclidian distance or a weighted Euclidian distance between the prediction vector and the measurement vector.

At stage 635, the module evaluation module processor 184 can determine a selected AD model for each sector, ADₘᵢₙ that mathematically minimizes the cost function evaluated at each sector. Memory 182 and/or memory 172 can store ADₘᵢₙ for each sector for use by the position determination module 170.

Following stage 635, the method 600 may return to stage 220 or stage 285 of method 200. The ADₘᵢₙ for each sector determined at stage 635 may be used at stage 220 or stage 285 of method 200 to determine the mobile device position.

Other embodiments are within the scope and spirit of the invention. For example, due to the nature of software, functions described above can be implemented using software, hardware, firmware, hardwiring, or combinations of any of these. Features implementing functions may also be physically located at various positions, including being distributed such that portions of functions are implemented at different physical locations.

Those of skill in the art would understand that information and signals may be represented using any of a variety of different technologies and techniques. For example, data, instructions, commands, information, signals, and symbols that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and algorithm steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium know in the art. A storage medium may be coupled, for example, to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more design examples, the functions described may be implemented in hardware, software, firmware, middleware, microcode, hardware description languages, or any combination thereof. When implemented in software, firmware, middleware, or microcode, the functions may be stored on or transmitted over as one or more instructions or code on a non-transitory computer-readable medium such as a computer storage medium. Processors may perform the described tasks.

Computer-readable media includes both computer storage media and communication media including any medium that facilitates transfer of a computer program from one place to another. A computer storage medium includes any medium that facilitates transfer of a computer program from one place to another. A computer storage media may be any available media that can be accessed by a general purpose or special purpose computer. By way of example, and not limitations, such computer-readable media can include RAM, ROM, EEPROM, CD-RIM or other optical disk storage, magnetic disk storage or other magnetic storage devices, or any other medium that can be used to carry or store desired program code means in the form of instructions or data structures and that can be accessed by a general-purpose or special purpose computer, or a general purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or mobile technologies such as infrared, radio, and microwave, then the coaxial cable, fiber optic cable, twisted pair, DSL, or mobile technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer readable media.

The methods, systems, and devices discussed above are examples. Various alternative configurations may omit, substitute, or add various procedures or components as appropriate. Configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered. Accordingly, the above description does not limit the scope of the claims. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

The previous description of the disclosure is provided to enable any person skilled in the art to make or use the disclosure. Various modifications to the disclosure will be readily apparent to those skilled in the art, and the generic principles defined herein may be applied to other variations without departing from the scope of the disclosure. Thus, the disclosure is not intended to be limited to the examples and designs described herein but is to be accorded the widest scope consistent with the principles and novel features disclosed herein.

As used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C), or combinations with more than one feature (e.g., AA, AAB, ABBC, etc.).

As used herein, including in the claims, unless otherwise stated, a statement that a function or operation is “based on” an item or condition means that the function or operation is based on the stated item or condition and may be based on one or more items and/or conditions in addition to the stated item or condition.

“First” as used herein refers to a first occurrence associated with the method 200 and/or the method 300. Unless stated otherwise, “first” does not necessitate or imply the absolute first. For example, “first” does not require the first positioning request to be the first positioning request ever received for one or more mobile devices 110-a and/or 110-b and/or c nor does “first” necessitate that the first positioning request be the first positioning request ever received in association with the network service area of the network 130.

Further, while the description above refers to the invention, the description may include more than one invention.

What is claimed is:

1. A method of determining a position of a mobile device in a network service area, the method comprising:
receiving a first positioning request for the position of the mobile device; and
in response to receiving the first positioning request,
receiving first signal characteristic measurements;
estimating a first a priori mobile device position area based on the first signal characteristic measurements;
determining a selected assistance data (AD) model; and
determining the position of the mobile device using the selected AD model.

2. The method of claim 1 comprising:
storing a first position information based on the position of the mobile device.

3. The method of claim 1 comprising:
sending a first position information based on the position of the mobile device.

4. The method of claim 1 wherein determining the selected AD model comprises:
calculating signal characteristics for each AD model of a set of AD models;
comparing the calculated signal characteristics with the first signal characteristic measurements to determine a first deviation for each AD model;
determining a first confidence score for each AD model wherein the first confidence score is based on the first deviation;
comparing the first confidence score of each AD model to a confidence score threshold to determine a first qualifying set of AD models;
determining a first cost function wherein the first cost function is based on the first qualifying set of AD models and the first signal characteristic measurements; and
determining the selected AD model wherein the selected AD model minimizes the first cost function and is one AD model of the first qualifying set of AD models.

5. The method of claim 4 wherein the confidence score threshold is heuristically determined and adjustable.

6. The method of claim 4 comprising:
comparing the calculated signal characteristics with a statistical parameter based on the first signal characteristic measurements and stored signal characteristic measurements to determine the first deviation for each AD model wherein the statistical parameter comprises a mean or a weighted mean.

7. The method of claim 1, wherein the network service area is divided into a plurality of sectors, each sector of the plurality of sectors being a section of the network service area, wherein determining the selected AD model comprises:
calculating signal characteristics for each sector for each AD model of a set of AD models;
comparing the first signal characteristic measurements with the calculated signal characteristics for each sector to determine a first deviation for each AD model for each sector;
determining a first confidence score for each AD model for each sector based on the first deviation for each AD model for each sector;
comparing the first confidence score of each AD model for each sector to a confidence score threshold to determine a first qualifying set of AD models for each sector;
determining a first cost function wherein the first cost function is based on the first qualifying set of AD models for each sector and the first signal characteristic measurements; and
determining the selected AD model for each sector wherein the selected AD model for each sector minimizes the first cost function evaluated at each sector and is one AD model of the first qualifying set of AD models.

8. The method of claim 7 wherein a number of sectors is dynamically adjusted based on the determined confidence score for each AD model.

9. The method of claim 1 wherein the network service area is divided into a plurality of sectors, each sector of the plurality of sectors being a section of the network service area, wherein determining the selected AD model comprises:
calculating signal characteristics for each sector within the estimated first a priori mobile device position area for each AD model of a set of AD models;
comparing the first signal characteristic measurements with the calculated signal characteristics for each sector within the estimated first a priori mobile device position area to determine a first deviation for each AD model for each sector within the estimated first a priori mobile device position area;
determining a first confidence score for each AD model for each sector within the estimated first a priori mobile device position area based on the first deviation for each AD model for each sector within the estimated first a priori mobile device position area;
comparing the first confidence score of each AD model for each sector within the estimated first a priori mobile device position area to a confidence score threshold to determine a first qualifying set of AD models for each sector within the estimated first a priori mobile device position area;
determining a first cost function wherein the first cost function is based on the first qualifying set of AD models for each sector within the estimated first a priori mobile device position area and the first signal characteristic measurements; and
determining the selected AD model for each sector within the estimated first a priori mobile device position area wherein the selected AD model for each sector within the estimated first a priori mobile device position area minimizes the first cost function evaluated at each sector within the estimated first a priori mobile device position area and is one AD model of the set of qualifying AD models.

10. The method of claim 1 comprising:
receiving a second positioning request; and
in response to receiving the second positioning request,
receiving second signal characteristic measurements;
estimating a second a priori mobile device position area based on the second signal characteristic measurements;
determining a selected AD model confidence score based on the second signal characteristic measurements; and
determining the selected AD model confidence score to be an acceptable confidence score or an unacceptable confidence score.

11. The method of claim 10 comprising:
in response to the selected AD model confidence score being the acceptable confidence score,
calculating signal characteristics for each AD model of a set of AD models;
comparing the second signal characteristic measurements with the calculated signal characteristics to determine a second deviation for each AD model;
determining a second confidence score for each AD model wherein the second confidence score is based on the second deviation; and
determining the position of the mobile device using the selected AD model.

12. The method of claim 10 comprising:
in response to the selected AD model confidence score being the unacceptable confidence score,
calculating signal characteristics for each AD model of a set of AD models;
comparing the second signal characteristic measurements with the calculated signal characteristics to determine a second deviation for each AD model; and
determining a second confidence score for each AD model wherein the second confidence score is based on the second deviation;
comparing the second confidence score of each AD model to a confidence score threshold to determine a second qualifying set of AD models;
determining a second cost function wherein the second cost function is based on the second qualifying set of AD models and the second signal characteristic measurements;
determining an updated selected AD model wherein the updated selected AD model minimizes the second cost function and is one AD model of the qualifying set of AD models; and
determining the position of the mobile device using the updated selected AD model.

13. A method of determining a position of a mobile device in a network service area, the method comprising:
sending a first positioning request; and
in response to the first positioning request, receiving first position information based on the position of the mobile device determined by:
receiving first signal characteristic measurements;
estimating a first a priori mobile device position area based on the first signal characteristic measurements;
determining a selected assistance data (AD) model; and
determining the position of the mobile device using the selected AD model.

14. The method of claim 13 wherein determining the selected AD model comprises:
calculating signal characteristics for each AD model of a set of AD models;
comparing the calculated signal characteristics with the first signal characteristic measurements to determine a first deviation for each AD model;
determining a first confidence score for each AD model wherein the first confidence score is based on the first deviation;
comparing the first confidence score of each AD model to a confidence score threshold to determine a first qualifying set of AD models;
determining a first cost function wherein the first cost function is based on the first qualifying set of AD models and the first signal characteristic measurements; and
determining the selected AD model wherein the selected AD model minimizes the first cost function and is one AD model of the first qualifying set of AD models.

15. The method of claim 13, wherein the network service area is divided into a plurality of sectors, each sector of the plurality of sectors being a section of the network service area, wherein determining the selected AD model comprises:
calculating signal characteristics for each sector for each AD model of a set of AD models;
comparing the first signal characteristic measurements with the calculated signal characteristics for each sector to determine a first deviation for each AD model for each sector;
determining a first confidence score for each AD model for each sector based on the first deviation for each AD model for each sector;
comparing the first confidence score of each AD model for each sector to a confidence score threshold to determine a first qualifying set of AD models for each sector;
determining a first cost function wherein the first cost function is based on the first qualifying set of AD models for each sector and the first signal characteristic measurements; and
determining the selected AD model for each sector wherein the selected AD model for each sector minimizes the first cost function evaluated at each sector and is one AD model of the first qualifying set of AD models.

16. The method of claim 13 comprising:
sending a second positioning request; and
in response to the second positioning request, receiving second position information based on the position of the mobile device determined by:
receiving second signal characteristic measurements;
estimating a second a priori mobile device position area based on the second signal characteristic measurements;
determining a selected AD model confidence score based on the second signal characteristic measurements;
determining the selected AD model confidence score to be an acceptable confidence score or an unacceptable confidence score;
in response to the selected AD model confidence score being the acceptable confidence score,
calculating signal characteristics for each AD model of a set of AD models;
comparing the second signal characteristic measurements with the calculated signal characteristics to determine a second deviation for each AD model;
determining a second confidence score for each AD model wherein the second confidence score is based on the second deviation;
determining the position of the mobile device using the selected AD model; and
in response to the confidence score of the selected AD model being the unacceptable confidence score,
calculating signal characteristics for each AD model of the set of AD models;
comparing the second signal characteristic measurements with the calculated signal characteristics to determine the second deviation for each AD model; and
determining the second confidence score for each AD model wherein the second confidence score is based on the second deviation;
comparing the second confidence score of each AD model to a confidence score threshold to determine a second qualifying set of AD models;
determining a second cost function wherein the second cost function is based on the second qualifying set of AD models and the second signal characteristic measurements;
determining an updated selected AD model wherein the updated selected AD model minimizes the second cost function and is one AD model of the set of AD models; and
determining the position of the mobile device using the updated selected AD model.

17. An apparatus for determining a position of a mobile device in a network service area, the apparatus comprising:
one or more processors configured to receive a first positioning request for the position of the mobile device; and
the one or more processors configured to, in response to receiving the first positioning request,
receive first signal characteristic measurements;
estimate a first a priori mobile device position area based on the first signal characteristic measurements;
determine a selected assistance data (AD) model; and
determine the position of the mobile device using the selected AD model.

18. The apparatus of claim 17 comprising:
a memory configured to store a first position information based on the position of the mobile device.

19. The apparatus of claim 17 wherein the one or more processors are configured to send a first position information based on the position of the mobile device.

20. The apparatus of claim 17 wherein the one or more processors are configured to determine the selected AD model by:
calculating signal characteristics for each AD model of a set of AD models;
comparing the calculated signal characteristics with the first signal characteristic measurements to determine a first deviation for each AD model;
determining a first confidence score for each AD model wherein the first confidence score is based on the first deviation;
comparing the first confidence score of each AD model to a confidence score threshold to determine a first qualifying set of AD models;
determining a first cost function wherein the first cost function is based on the first qualifying set of AD models and the first signal characteristic measurements; and
determining the selected AD model wherein the selected AD model minimizes the first cost function and is one AD model of the first qualifying set of AD models.

21. The apparatus of claim 20 wherein the confidence score threshold is heuristically determined and adjustable.

22. The apparatus of claim 20 wherein the one or more processors are configured to compare the calculated signal characteristics with a statistical parameter based on the first signal characteristic measurements and stored signal characteristic measurements to determine the first deviation for each AD model wherein the statistical parameter comprises a mean or a weighted mean.

23. The apparatus of claim 17, wherein the network service area is divided into a plurality of sectors, each sector of the plurality of sectors being a section of the network service area, wherein the one or more processors are configured to determine the selected AD model by steps comprising:
calculating signal characteristics for each sector for each AD model of a set of AD models;
comparing the first signal characteristic measurements with the calculated signal characteristics for each sector to determine a first deviation for each AD model for each sector;
determining a first confidence score for each AD model for each sector based on the first deviation for each AD model for each sector;
comparing the first confidence score of each AD model for each sector to a confidence score threshold to determine a first qualifying set of AD models for each sector;
determining a first cost function wherein the first cost function is based on the first qualifying set of AD models for each sector and the first signal characteristic measurements; and
determining the selected AD model for each sector wherein the selected AD model for each sector minimizes the first cost function evaluated at each sector and is one AD model of the first qualifying set of AD models.

24. The apparatus of claim 23 wherein a number of sectors is dynamically adjusted based on the determined confidence score for each AD model.

25. The apparatus of claim 17 wherein the network service area is divided into a plurality of sectors, each sector of the plurality of sectors being a section of the network service area, wherein the one or more processors are configured to determine the selected AD model by steps comprising:
calculating signal characteristics for each sector within the estimated first a priori mobile device position area for each AD model of a set of AD models;
comparing the first signal characteristic measurements with the calculated signal characteristics for each sector within the estimated first a priori mobile device position area to determine a first deviation for each AD model for each sector within the estimated first a priori mobile device position area;
determining a first confidence score for each AD model for each sector within the estimated first a priori mobile device position area based on the first deviation for each AD model for each sector within the estimated first a priori mobile device position area;
comparing the first confidence score of each AD model for each sector within the estimated first a priori mobile device position area to a confidence score threshold to determine a first qualifying set of AD models for each sector within the estimated first a priori mobile device position area;
determining a first cost function wherein the first cost function is based on the first qualifying set of AD models for each sector within the estimated first a priori mobile device position area and the first signal characteristic measurements; and
determining the selected AD model for each sector within the estimated first a priori mobile device position area wherein the selected AD model for each sector within the estimated first a priori mobile device position area minimizes the first cost function evaluated at each sector within the estimated first a priori mobile device position area and is one AD model of the set of qualifying AD models.

26. The apparatus of claim 17 wherein the one or more processors are configured to:
receive a second positioning request; and
in response to receiving the second positioning request,
receive second signal characteristic measurements;
estimate a second a priori mobile device position area based on the second signal characteristic measurements;
determine a selected AD model confidence score based on the second signal characteristic measurements; and
determine the selected AD model confidence score to be an acceptable confidence score or an unacceptable confidence score.

27. The apparatus of claim 26 wherein the one or more processors are configured to:
in response to the selected AD model confidence score being the acceptable confidence score,
calculate signal characteristics for each AD model of the set of AD models;
compare the second signal characteristic measurements with the calculated signal characteristics to determine a second deviation for each AD model;
determine a second confidence score for each AD model wherein the second confidence score is based on the second deviation; and
determine the position of the second mobile device using the selected AD model.

28. The apparatus of claim 26 wherein the one or more processors are configured to, in response to the selected AD model confidence score being the unacceptable confidence score:
calculate signal characteristics for each AD model of a set of AD models;
compare the second signal characteristic measurements with the calculated signal characteristics to determine the second deviation for each AD model;
determine a second confidence score for each AD model wherein the second confidence score is based on the second deviation;
compare the second confidence score of each AD model to a confidence score threshold to determine a second qualifying set of AD models;
determine a second cost function wherein the second cost function is based on the second qualifying set of AD models and the second signal characteristic measurements; and
determine an updated selected AD model wherein the updated selected AD model minimizes the second cost function and is one AD model of the qualifying set of AD models; and
determine the position of the second mobile device using the updated selected AD model.

29. An apparatus for determining a position of a mobile device in a network service area, the apparatus comprising a transceiver configured to:
send a first positioning request; and
in response to the first positioning request, receive first position information based on the first position of the mobile device determined by:
receiving first signal characteristic measurements;
estimating a first a priori mobile device position area based on the first signal characteristic measurements;
determining a selected assistance data (AD) model; and
determining the first position of the mobile device using the selected AD model.

30. The apparatus of claim 29 wherein determining the selected AD model comprises:
calculating signal characteristics for each AD model of a set of AD models;
comparing the calculated signal characteristics with the first signal characteristic measurements to determine a first deviation for each AD model;
determining a first confidence score for each AD model wherein the first confidence score is based on the first deviation;
comparing the first confidence score of each AD model to a confidence score threshold to determine a first qualifying set of AD models;
determining a first cost function wherein the first cost function is based on the first qualifying set of AD models and the first signal characteristic measurements; and
determining the selected AD model wherein the selected AD model minimizes the first cost function and is one AD model of the first qualifying set of AD models.

31. The apparatus of claim 29, wherein the network service area is divided into a plurality of sectors, each sector of the plurality of sectors being a section of the network service area, wherein determining the selected AD model comprises:
calculating signal characteristics for each sector for each AD model of a set of AD models;
comparing the first signal characteristic measurements with the calculated signal characteristics for each sector to determine a first deviation for each AD model for each sector;
determining a first confidence score for each AD model for each sector based on the first deviation for each AD model for each sector;
comparing the first confidence score of each AD model for each sector to a confidence score threshold to determine a first qualifying set of AD models for each sector;
determining a first cost function wherein the first cost function is based on the first qualifying set of AD models for each sector and the first signal characteristic measurements; and
determining the selected AD model for each sector wherein the selected AD model for each sector minimizes the first cost function evaluated at each sector and is one AD model of the first qualifying set of AD models.

32. The apparatus of claim 29 wherein the transceiver is configured to:
send a second positioning request; and
in response to the second positioning request, receive second position information based on the position of the mobile device determined by:
receiving second signal characteristic measurements;
estimating a second a priori mobile device position area based on the second signal characteristic measurements;
determining a selected AD model confidence score based on the second signal characteristic measurements;
determining the selected AD model confidence score to be an acceptable confidence score or an unacceptable confidence score;
in response to the selected AD model confidence score being the acceptable confidence score,
calculating signal characteristics for each AD model of a set of AD models;
comparing the second signal characteristic measurements with the calculated signal characteristics to determine a second deviation for each AD model;
determining a second confidence score for each AD model wherein the second confidence score is based on the second deviation; and
determining the position of the mobile device using the selected AD model; and
in response to the confidence score of the selected AD model being the unacceptable confidence score,
calculating signal characteristics for each AD model of the set of AD models;
comparing the second signal characteristic measurements with the calculated signal characteristics to determine the second deviation for each AD model;
determining the second confidence score for each AD model wherein the second confidence score is based on the second deviation;
comparing the second confidence score of each AD model to a confidence score threshold to determine a second qualifying set of AD models;
determining a second cost function wherein the second cost function is based on the second qualifying set of AD models and the second signal characteristic measurements;
determining an updated selected AD model wherein the updated selected AD model minimizes the second cost function and is one AD model of the set of AD models; and
determining the position of the mobile device using the updated selected AD model.

33. An apparatus for determining a position of a mobile device in a network service area, the apparatus comprising:
means for receiving a first positioning request for the position of the mobile device; and
means for, in response to receiving the first positioning request:
receiving first signal characteristic measurements;
estimating a first a priori mobile device position area based on the first signal characteristic measurements;
determining a selected assistance data (AD) model; and
determining the position of the mobile device using the selected AD model.

34. The apparatus of claim 33 comprising means for storing a first position information based on the position of the mobile device.

35. The apparatus of claim 33 comprising means for sending a first position information based on the position of the mobile device.

36. The apparatus of claim 33 wherein the means for determining the selected AD model comprises:
means for calculating signal characteristics for each AD model of a set of AD models;
means for comparing the calculated signal characteristics with the first signal characteristic measurements to determine a first deviation for each AD model;
means for determining a first confidence score for each AD model wherein the first confidence score is based on the first deviation;
means for comparing the first confidence score of each AD model to a confidence score threshold to determine a first qualifying set of AD models;
means for determining a first cost function wherein the first cost function is based on the first qualifying set of AD models and the first signal characteristic measurements; and
means for determining the selected AD model wherein the selected AD model minimizes the first cost function and is one AD model of the first qualifying set of AD models.

37. The apparatus of claim 36 wherein the confidence score threshold is heuristically determined and adjustable.

38. The apparatus of claim 36 comprising:
means for comparing the calculated signal characteristics with a statistical parameter based on the first signal characteristic measurements and stored signal characteristic measurements to determine a first deviation for each AD model wherein the statistical parameter comprises a mean or a weighted mean.

39. The apparatus of claim 33, wherein the network service area is divided into a plurality of sectors, each sector of the plurality of sectors being a section of the network service area, wherein the means for determining the selected AD model comprises:
means for calculating signal characteristics for each sector for each AD model of a set of AD models;
means for comparing the first signal characteristic measurements with the calculated signal characteristics for each sector to determine a first deviation for each AD model for each sector;
means for determining a first confidence score for each AD model for each sector based on the first deviation for each AD model for each sector;
means for comparing the first confidence score of each AD model for each sector to a confidence score threshold to determine a first qualifying set of AD models for each sector;
means for determining a first cost function wherein the first cost function is based on the first qualifying set of AD models for each sector and the first signal characteristic measurements; and
means for determining the selected AD model for each sector wherein the selected AD model for each sector minimizes the first cost function evaluated at each sector and is one AD model of the first qualifying set of AD models.

40. The apparatus of claim 39 wherein a number of sectors is dynamically adjusted based on the determined confidence score for each AD model.

41. The apparatus of claim 33 wherein the network service area is divided into a plurality of sectors, each sector of the plurality of sectors being a section of the network service area, wherein the means for determining the selected AD model comprises:
means for calculating signal characteristics for each sector within the estimated first a priori mobile device position area for each AD model of a set of AD models;
means for comparing the first signal characteristic measurements with the calculated signal characteristics for each sector within the estimated first a priori mobile device position area to determine a first deviation for each AD model for each sector within the estimated first a priori mobile device position area;
means for determining a first confidence score for each AD model for each sector within the estimated first a priori mobile device position area based on the first deviation for each AD model for each sector within the estimated first a priori mobile device position area;
means for comparing the first confidence score of each AD model for each sector within the estimated first a priori mobile device position area to a confidence score threshold to determine a first qualifying set of AD models for each sector within the estimated first a priori mobile device position area;
means for determining a first cost function wherein the first cost function is based on the first qualifying set of AD models for each sector within the estimated first a priori mobile device position area and the first signal characteristic measurements; and
means for determining the selected AD model for each sector within the estimated first a priori mobile device position area wherein the selected AD model for each sector within the estimated first a priori mobile device position area minimizes the first cost function evaluated at each sector within the estimated first a priori mobile device position area and is one AD model of the set of qualifying AD models.

42. The apparatus of claim 33 comprising:
means for receiving a second positioning request
means for, in response to receiving the second positioning request:
receiving second signal characteristic measurements;
estimating a second a priori mobile device position area based on the second signal characteristic measurements;
determining a selected AD model confidence score based on the second signal characteristic measurements; and
determining the selected AD model confidence score to be an acceptable confidence score or an unacceptable confidence score.

43. The apparatus of claim 42 comprising:
means for, in response to the selected AD model confidence score being the acceptable confidence score:
calculating signal characteristics for each AD model of a set of AD models;
comparing the second signal characteristic measurements with the calculated signal characteristics to determine a second deviation for each AD model;
determining a second confidence score for each AD model wherein the second confidence score is based on the second deviation; and
determining the position of the mobile device using the selected AD model.

44. The apparatus of claim 42 comprising:
means for, in response to the confidence score of the selected AD model being the unacceptable confidence score:
calculating signal characteristics for each AD model of a set of AD models;
comparing the second signal characteristic measurements with the calculated signal characteristics to determine a second deviation for each AD model;
determining a second confidence score for each AD model wherein the second confidence score is based on the second deviation;
comparing the second confidence score of each AD model to a confidence score threshold to determine a second qualifying set of AD models;
determining a second cost function wherein the second cost function is based on the second qualifying set of AD models and the second signal characteristic measurements;
determining an updated selected AD model wherein the updated selected AD model minimizes the second cost function and is one AD model of the qualifying set of AD models; and
determining the position of the mobile device using the updated selected AD model.

45. An apparatus for determining a position of a mobile device in a network service area, the apparatus comprising:
means for sending a first positioning request; and
means for receiving first position information based on the position of the mobile device determined, in response to the first positioning request, by:
receiving first signal characteristic measurements;
estimating a first a priori mobile device position area based on the first signal characteristic measurements;
determining a selected assistance data (AD) model; and
determining the position of the mobile device using the selected AD model.

46. The apparatus of claim 45 wherein determining the selected AD model comprises:
calculating signal characteristics for each AD model of a set of AD models;
comparing the calculated signal characteristics with the first signal characteristic measurements to determine a first deviation for each AD model;
determining a first confidence score for each AD model wherein the first confidence score is based on the first deviation;
comparing the first confidence score of each AD model to a confidence score threshold to determine a first qualifying set of AD models;
determining a first cost function wherein the first cost function is based on the first qualifying set of AD models and the first signal characteristic measurements; and
determining the selected AD model wherein the selected AD model minimizes the first cost function and is one AD model of the first qualifying set of AD models.

47. The apparatus of claim 45, wherein the network service area is divided into a plurality of sectors, each sector of the plurality of sectors being a section of the network service area, wherein determining the selected AD model comprises:
calculating signal characteristics for each sector for each AD model of a set of AD models;
comparing the first signal characteristic measurements with the calculated signal characteristics for each sector to determine a first deviation for each AD model for each sector;
determining a first confidence score for each AD model for each sector based on the first deviation for each AD model for each sector;
comparing the first confidence score of each AD model for each sector to a confidence score threshold to determine a first qualifying set of AD models for each sector;
determining a first cost function wherein the first cost function is based on the first qualifying set of AD models for each sector and the first signal characteristic measurements; and
determining the selected AD model for each sector wherein the selected AD model for each sector minimizes the first cost function evaluated at each sector and is one AD model of the first qualifying set of AD models.

48. The apparatus of claim 45 comprising:
means for sending a second positioning request; and
means for receiving second position information based on the position of the mobile device determined, in response to the second positioning request, by:
receiving second signal characteristic measurements;
estimating a second a priori mobile device position area based on the second signal characteristic measurements;
determining a selected AD model confidence score based on the second signal characteristic measurements;
determining the selected AD model confidence score to be an acceptable confidence score or an unacceptable confidence score;
in response to the selected AD model confidence score being the acceptable confidence score,
calculating signal characteristics for each AD model of a set of AD models;
comparing the second signal characteristic measurements with the calculated signal characteristics to determine a second deviation for each AD model;
determining a second confidence score for each AD model wherein the second confidence score is based on the second deviation; and
determining the position of the mobile device using the selected AD model; and
in response to the confidence score of the selected AD model being the unacceptable confidence score,
calculating signal characteristics for each AD model of the set of AD models;
comparing the second signal characteristic measurements with the calculated signal characteristics to determine the second deviation for each AD model;
determining the second confidence score for each AD model wherein the second confidence score is based on the second deviation;
comparing the second confidence score of each AD model to a confidence score threshold to determine a second qualifying set of AD models;
determining a second cost function wherein the second cost function is based on the second qualifying set of AD models and the second signal characteristic measurements;
determining an updated selected AD model wherein the updated selected AD model minimizes the second cost function and is one AD model of the set of AD models; and
determining the position of the mobile device using the updated selected AD model.

49. A computer program product residing on a processor-readable non-transitory storage medium and comprising processor-readable instructions executable by one or more processors to:
receive a first positioning request for a position of a mobile device; and
in response to receiving the first positioning request,
receive first signal characteristic measurements;
estimate a first a priori mobile device position area based on the first signal characteristic measurements;
determine a selected assistance data (AD) model; and
determine the position of the mobile device to be the position of the mobile device determined using the selected AD model.

50. The computer program product of claim 49 comprising processor-readable instructions executable by one or more processors to:
store a first position information based on the position of the mobile device.

51. The computer program product of claim 49 comprising processor-readable instructions executable by one or more processors to:
send a first position information based on the position of the mobile device.

52. The computer program product of claim 49 wherein processor-readable instructions executable by one or more processors to determine the selected AD model comprise instructions to:
calculate signal characteristics for each AD model of a set of AD models;
compare the calculated signal characteristics with the first signal characteristic measurements to determine a first deviation for each AD model;
determine a first confidence score for each AD model wherein the first confidence score is based on the first deviation;
compare the first confidence score of each AD model to a confidence score threshold to determine a first qualifying set of AD models;
determine a first cost function wherein the first cost function is based on the first qualifying set of AD models and the first signal characteristic measurements; and
determine the selected AD model wherein the selected AD model minimizes the first cost function and is one AD model of the first qualifying set of AD models.

53. The computer program product of claim 52 wherein the confidence score threshold is heuristically determined and adjustable.

54. The computer program product of claim 52 comprising processor-readable instructions executable by one or more processors to:
compare the calculated signal characteristics with a statistical parameter based on the first signal characteristic measurements and stored signal characteristic measurements to determine a first deviation for each AD model wherein the statistical parameter comprises a mean or a weighted mean.

55. The computer program product of claim 49, wherein the network service area is divided into a plurality of sectors, each sector of the plurality of sectors being a section of the network service area, wherein processor-readable instructions executable by one or more processors to determine the selected AD model comprise instructions to:
calculate signal characteristics for each sector for each AD model of a set of AD models;
compare the first signal characteristic measurements with the calculated signal characteristics for each sector to determine a first deviation for each AD model for each sector;
determine a first confidence score for each AD model for each sector based on the first deviation for each AD model for each sector;
compare the first confidence score of each AD model for each sector to a confidence score threshold to determine a first qualifying set of AD models for each sector;
determine a first cost function wherein the first cost function is based on the first qualifying set of AD models for each sector and the first signal characteristic measurements; and
determine the selected AD model for each sector wherein the selected AD model for each sector minimizes the first cost function evaluated at each sector and is one AD model of the first qualifying set of AD models.

56. The computer program product of claim 55 wherein a number of sectors is dynamically adjusted based on the determined confidence score for each AD model.

57. The computer program product of claim 49, wherein the network service area is divided into a plurality of sectors, each sector of the plurality of sectors being a section of the network service area, wherein processor-readable instructions executable by one or more processors to determine the selected AD model comprise instructions to:
calculate signal characteristics for each sector within the estimated first a priori mobile device position area for each AD model of a set of AD models;
compare the first signal characteristic measurements with the calculated signal characteristics for each sector within the estimated first a priori mobile device position area to determine a first deviation for each AD model for each sector within the estimated first a priori mobile device position area;
determine a first confidence score for each AD model for each sector within the estimated first a priori mobile device position area based on the first deviation for each AD model for each sector within the estimated first a priori mobile device position area;
compare the first confidence score of each AD model for each sector within the estimated first a priori mobile device position area to a confidence score threshold to determine a first qualifying set of AD models for each sector within the estimated first a priori mobile device position area;
determine a first cost function wherein the first cost function is based on the first qualifying set of AD models for each sector within the estimated first a priori mobile device position area and the first signal characteristic measurements; and
determine the selected AD model for each sector within the estimated first a priori mobile device position area wherein the selected AD model for each sector within the estimated first a priori mobile device position area minimizes the first cost function evaluated at each sector within the estimated first a priori mobile device position area and is one AD model of the set of qualifying AD models.

58. The computer program product of claim 49 comprising processor-readable instructions executable by one or more processors to:
receive a second positioning request; and
in response to receiving the second positioning request,
receive second signal characteristic measurements;
estimate a second a priori mobile device position area based on the second signal characteristic measurements;
determine a selected AD model confidence score based on the second signal characteristic measurements; and
determine the selected AD model confidence score to be an acceptable confidence score or an unacceptable confidence score.

59. The computer program product of claim 58 comprising processor-readable instructions executable by one or more processors to:
in response to the selected AD model confidence score being the acceptable confidence score,
calculate signal characteristics for each AD model of a set of AD models;
compare the second signal characteristic measurements with the calculated signal characteristics to determine a second deviation for each AD model;
determine a second confidence score for each AD model wherein the second confidence score is based on the second deviation; and
determine the position of the mobile device using the selected AD model.

60. The computer program product of claim 58 comprising processor-readable instructions executable by one or more processors to:
in response to the confidence score of the selected AD model being the unacceptable confidence score,
calculate signal characteristics for each AD model of a set of AD models;
compare the second signal characteristic measurements with the calculated signal characteristics to determine a second deviation for each AD model;
determine a second confidence score for each AD model wherein the second confidence score is based on the second deviation;
compare the second confidence score of each AD model to a confidence score threshold to determine a second qualifying set of AD models;
determine a second cost function wherein the second cost function is based on the second qualifying set of AD models and the second signal characteristic measurements;
determine an updated selected AD model wherein the updated selected AD model minimizes the second cost function and is one AD model of the qualifying set of AD models; and
determine the position of the mobile device using the updated selected AD model.

61. A computer program product residing on a processor-readable non-transitory storage medium and comprising processor-readable instructions executable by one or more processors to:
send a first positioning request; and
receive first position information based on the position of the mobile device determined, in response to the first positioning request, by:
receiving first signal characteristic measurements;
estimating a first a priori mobile device position area based on the first signal characteristic measurements;
determining a selected assistance data (AD) model; and
determining the position of the mobile device using the selected AD model.

62. The computer program product of claim 61 wherein determining the selected AD model comprises:
calculating signal characteristics for each AD model of a set of AD models;
comparing the calculated signal characteristics with the first signal characteristic measurements to determine a first deviation for each AD model;
determining a first confidence score for each AD model wherein the first confidence score is based on the first deviation;
comparing the first confidence score of each AD model to a confidence score threshold to determine a first qualifying set of AD models;
determining a first cost function wherein the first cost function is based on the first qualifying set of AD models and the first signal characteristic measurements; and
determining the selected AD model wherein the selected AD model minimizes the first cost function and is one AD model of the first qualifying set of AD models.

63. The computer program product of claim 61, wherein the network service area is divided into a plurality of sectors, each sector of the plurality of sectors being a section of the network service area, wherein determining the selected AD model comprises:
calculating signal characteristics for each sector for each AD model of a set of AD models;
comparing the first signal characteristic measurements with the calculated signal characteristics for each sector to determine a first deviation for each AD model for each sector;
determining a first confidence score for each AD model for each sector based on the first deviation for each AD model for each sector;
comparing the first confidence score of each AD model for each sector to a confidence score threshold to determine a first qualifying set of AD models for each sector;
determining a first cost function wherein the first cost function is based on the first qualifying set of AD models for each sector and the first signal characteristic measurements; and
determining the selected AD model for each sector wherein the selected AD model for each sector minimizes the first cost function evaluated at each sector and is one AD model of the first qualifying set of AD models.

64. The computer program product of claim 61 comprising processor-readable instructions executable by one or more processors to:
send a second positioning request; and
in response to the second positioning request, receive second position information based on the position of the mobile device determined by:
receiving second signal characteristic measurements;
estimating a second a priori mobile device position area based on the second signal characteristic measurements;
determining a selected AD model confidence score based on the second signal characteristic measurements;
determining the selected AD model confidence score to be an acceptable confidence score or an unacceptable confidence score;
in response to the selected AD model confidence score being the acceptable confidence score,
calculating signal characteristics for each AD model of a set of AD models;
comparing the second signal characteristic measurements with the calculated signal characteristics to determine a second deviation for each AD model;
determining a second confidence score for each AD model wherein the second confidence score is based on the second deviation; and
determining the position of the mobile device using the selected AD model; and
in response to the confidence score of the selected AD model being the unacceptable confidence score,
calculating signal characteristics for each AD model of the set of AD models;
comparing the second signal characteristic measurements with the calculated signal characteristics to determine the second deviation for each AD model;
determining the second confidence score for each AD model wherein the second confidence score is based on the second deviation;
comparing the second confidence score of each AD model to a confidence score threshold to determine a second qualifying set of AD models;
determining a second cost function wherein the second cost function is based on the second qualifying set of AD models and the second signal characteristic measurements;
determining an updated selected AD model wherein the updated selected AD model minimizes the second cost function and is one AD model of the set of AD models; and
determining the position of the mobile device using the updated selected AD model.
